(19) United States
(12) Patent Application Publication
(10) Pub. No.: US 2025/0076806 A1
(43) Pub. Date: Mar. 6, 2025

(54) IMAGE FORMING APPARATUS

(71) Applicant: CANON KABUSHIKI KAISHA, Tokyo (JP)

(72) Inventors: Yuichiro Hirata, Shizuoka (JP); Shunsuke Matsushita, Kanagawa (JP); Takuya Oka, Kanagawa (JP)

(21) Appl. No.: 18/798,899

(22) Filed: Aug. 9, 2024

(30) Foreign Application Priority Data
Aug. 31, 2023 (JP) 2023-141097

(51) Int. Cl. G03G 15/00; G03G 15/08

(52) U.S. Cl. CPC G03G 15/556; G03G 15/0865

(57) ABSTRACT

An image forming apparatus includes a photosensitive drum, a developing unit including an accommodating portion and a developing roller, a notifying portion, and a controller. In a case where a cumulative movement distance obtained by integrating a movement distance of the developing roller in a predetermined section of a surface of the developing roller from initial use of the developing unit is a predetermined first supply discrimination threshold or more, the controller controls the notifying portion so as to provide notification prompting a user to supply a developer.

### FIELD OF THE INVENTION AND RELATED ART

The present invention relates to an image forming apparatus.

In a developing device of an image forming apparatus of an electrophotographic image forming type, toner carried on a developing roller is continuously rubbed with a supplying roller for supplying the toner, accommodated in the developing device, to the developing roller and with a developing blade for regulating a toner amount of the toner on the developing roller. By this rubbing, liberation and embedding of an external additive or the like added to the toner occur, and the toner is gradually deteriorated with an increasing number of times of image formation. Further, filming such that the external additive and fine particle toner which are liberated from the toner are adhered to and deposited on a surface of the developing roller occurs, so that a toner carrying force and chargeability of the developing roller lower and cause an image defect.

In Japanese Patent No. 4743273, a constitution in which a deterioration amount depending on a remaining toner amount of toner in a developing device of an image forming apparatus is calculated and thus a lifetime of the developing device is discriminated is disclosed. Further, in Japanese Laid-Open Patent Application (JP-A) 2016-161645, a constitution in which weighting of a developing roller use amount is changed depending on an environment in which the image forming apparatus is used and thus an exchange timing of a consumable is changed every use environment is disclosed.

In JP-A 2022-103540, a developing device capable of being supplied with toner from a supply change such as a toner pack or a toner bottle is disclosed. A toner supplying type includes a type in which toner in an amount corresponding to an amount of the toner consumed by an image forming operation is successively supplied and a type in which toner is collectively supplied in the case where the toner in the developing device is decreased in amount to a predetermined amount. In such an image forming apparatus to which the toner is capable of being supplied, there is a constitution in which in the case where a situation that the toner is not supplied is continued and the toner is consumed until the image forming apparatus is placed in a state in which appropriate image formation cannot be carried out, the image forming operation is interrupted and notification prompting an operator to supply the toner is provided.

In the image forming apparatus including the developing device capable of being supplied with the toner from the supply change as described in JP-A 2022-103540, when the suppl of the developer is executed, a deterioration state of the toner in the developing device changes. Further, a consumption state of the developing roller changes depending on the deterioration state of the toner in the developing device. For that reason, when discrimination of appropriate supply timing and arrival at an end of a lifetime in consideration of the deterioration state of the toner due to the supply and the consumption state of the developing roller is not made, there is a possibility that a fog due to filming of the developing roller and improper density of a half-tone image occur. In Japanese Patent No. 4743273 and JP-A 2016-161645, changes in deterioration state of the toner and consumption state of the developing roller due to the supply of the toner from the supply change to the developing device are not considered.

### SUMMARY OF THE INVENTION

A principal object of the present invention is to appropriately notify a supply timing of a developer to a developing device and a lifetime of the developing device in an image forming apparatus including the developing device to which a supply change for supplying the developer is detachably mountable.

According to an aspect of the present invention, there is provided an image forming apparatus comprising: a photosensitive drum on which an electrostatic latent image is formed on a surface thereof; a developing unit which includes an accommodating portion for accommodating a developer and a developing roller for supplying the developer from the accommodating portion to the photosensitive drum and to which a supply container for supplying the developer to the accommodating portion is detachably mountable; a notifying portion configured to provide notification to a user; and a controller configured to control the notifying portion, wherein in a case where a cumulative movement distance obtained by integrating a movement distance of the developing roller in a predetermined section of a surface of the developing roller from initial use of the developing unit is a predetermined first supply discrimination threshold or more, the controller controls the notifying portion so as to provide notification prompting the user to supply the developer.

According to another aspect of the present invention, there is provided an image forming apparatus comprising: a photosensitive drum on which an electrostatic latent image is formed on a surface thereof; a developing unit which includes an accommodating portion for accommodating a developer and a developing roller for supplying the developer from the accommodating portion to the photosensitive drum and to which a supply container for supplying the developer to the accommodating portion is detachably mountable; a notifying portion configured to provide notification to a user; and a controller configured to control the notifying portion, wherein in a case where a cumulative movement distance obtained by integrating a movement distance of the developing roller in a predetermined section of a surface of the developing roller from initial use of the developing unit is a predetermined lifetime discrimination threshold or more, the controller controls the notifying portion so as to provide notification to the effect that the developing unit reaches an end of a lifetime thereof.

Further features of the present invention will become apparent from the following description of exemplary embodiments with reference to the attached drawings.

### BRIEF DESCRIPTION OF THE DRAWING

FIG. 1 is a schematic sectional view of an image forming apparatus.

FIG. 2A is a schematic front view of a toner pack.

FIG. 2B is a schematic sectional view showing a state in which the toner pack is mounted to a developing device.

FIG. 3 is a schematic front view of a light guiding member of a toner amount sensor.

FIG. 4 is a circuit view of a sensor portion of the toner amount sensor.

FIG. 5A is a schematic block diagram showing a control system of the image forming apparatus.

FIG. 5B is a schematic block diagram showing a control system of an image forming apparatus of an embodiment 1.

FIG. 6A is a flowchart of a supply requirement/lifetime notification sequence in the embodiment 1.

FIG. 6B is a flowchart of the supply requirement (request)/lifetime notification sequence in the embodiment 1.

FIG. 7 shows an evaluation experiment result in the embodiment 1.

FIG. 8 is a schematic block diagram showing a control system of an image forming apparatus of an embodiment 2.

FIG. 9A is a flowchart of a supply requirement/lifetime notification sequence in the embodiment 2.

FIG. 9B is a flowchart of the supply requirement/lifetime notification sequence in the embodiment 2.

FIG. 10 shows an evaluation experiment result in the embodiment 2.

FIG. 11 is a schematic block diagram showing a control system of an image forming apparatus of each of embodiments 3 to 5.

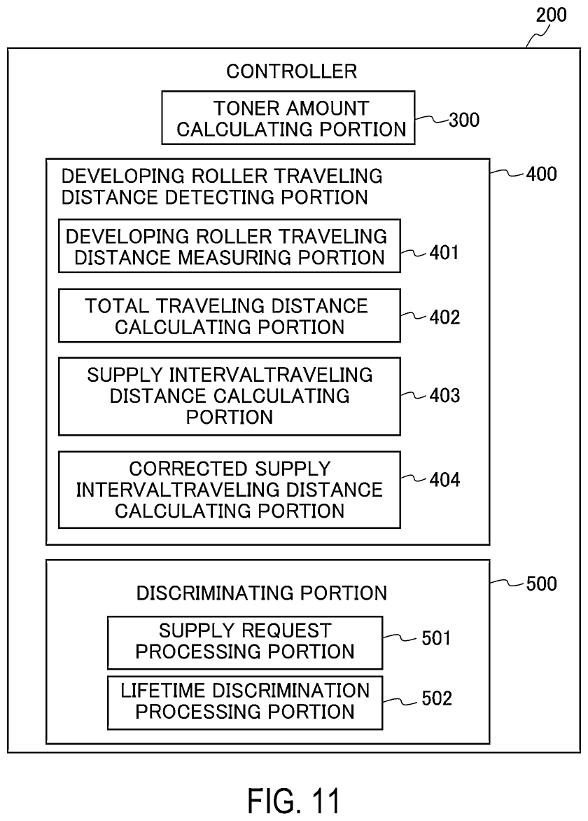

FIG. 12A is a flowchart of a supply requirement/lifetime notification sequence in the embodiment 3.

FIG. 12B is a flowchart of the supply requirement/lifetime notification sequence in the embodiment 3.

FIG. 13 shows a correction coefficient in the embodiment 3.

FIG. 14 shows a different example of the correction coefficient in the embodiment 3.

FIG. 15 shows an evaluation experiment result in the embodiment 3.

FIG. 16A is a flowchart of a supply requirement/lifetime notification sequence in the embodiment 4.

FIG. 16B is a flowchart of the supply requirement/notification lifetime sequence in the embodiment 4.

FIG. 17 shows a relationship between a toner supply amount and a correction coefficient in the embodiment 4.

FIG. 18 shows a relationship between the toner supply amount and a supply execution supply interval traveling distance threshold in the embodiment 4.

FIG. 19A is a flowchart of a supply requirement/lifetime notification sequence in the embodiment 5.

FIG. 19B is a flowchart of the supply requirement/lifetime notification sequence in the embodiment 5.

FIG. 20 shows a correction coefficient in the embodiment 5.

### DESCRIPTION OF THE EMBODIMENTS

In the following, an image forming apparatus according to the present invention will be described while making reference to the drawings. However, dimensions, materials, shapes, a relative arrangement, and the like of constituent elements described in the following embodiments should be appropriately changed depending on constitutions and various conditions of apparatuses to which the present invention is applied, and, the scope of the present invention is not intended to be limited to the following embodiments.

### <General Structure of Image Forming Apparatus>

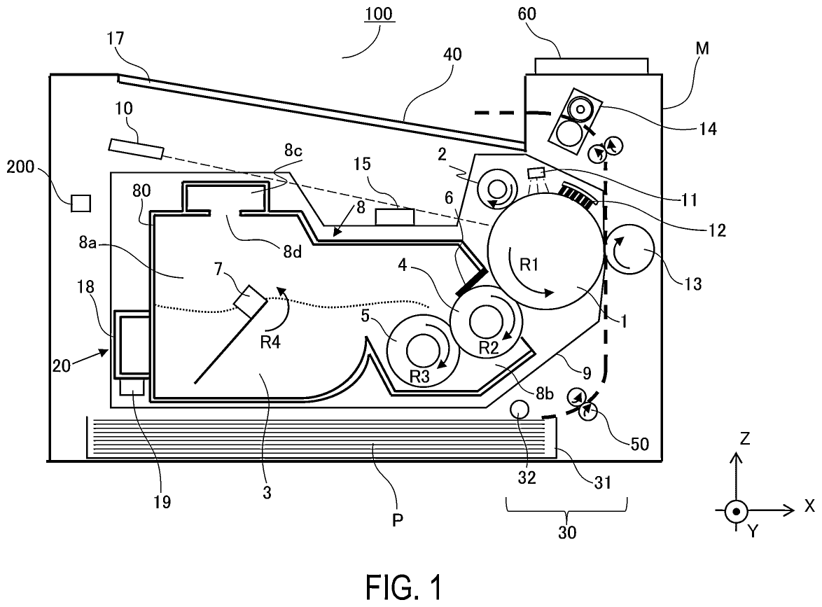

First, a general structure of an image forming apparatus 100 of an embodiment 1 will be described. FIG. 1 is a schematic sectional view of the image forming apparatus of the embodiment 1. In the following description, with respect to the image forming apparatus 100, a front-rear direction (left-right direction of FIG. 1) is an X direction, a left-right direction (direction perpendicular to the drawing sheet surface of FIG. 1) is a Y direction, and a vertical direction is a Z direction. The X direction and the Y direction are parallel to a horizontal direction, and the Y direction is parallel to rotational axis directions of a photosensitive drum 1, a charging roller 2, a developing roller 4, a supplying roller 5, a transfer roller 13, and the like. The image forming apparatus 100 of the embodiment 1 is a monochromatic laser printer capable of forming a black (monochromatic) image on a sheet-like recording material P by using an electrophotographic type, and a process cartridge 9 is configured so as to be detachably mountable to an apparatus main assembly M. Here, the apparatus main assembly M is a constitution portion excluding the process cartridge 9 from the image forming apparatus 100. Incidentally, the image forming apparatus to which the present invention is applicable is not limited to the image forming apparatus having a basic constitution described in the embodiment 1. For example, the present invention is also applicable to a color laser printer which includes a plurality of process cartridges detachably mountable thereto and which forms a full-color image or the like by transferring toner images of a plurality of colors on a recording material P by using an intermediary transfer member such as an intermediary transfer belt. Further, in the embodiment 1, to the image forming apparatus 100, the process cartridge 9 is detachably mountable, but the present invention is also applicable to an image forming apparatus in which a process unit similar in constitution to the process cartridge 9 in the embodiment 1 is provided in the apparatus main assembly.

The process cartridge 9 includes the photosensitive drum 1 which is a rotatable drum-shaped (cylindrical) photosensitive member (electrophotographic photosensitive member) as an image bearing member on which surface an electrostatic latent image is formed. Further, the process cartridge 9 includes, at a periphery of the photosensitive drum 1, the charging roller 2 which is a roller-shaped charging member as a charging means and a developing device 8 as a developing means. Further, the process cartridge includes, at the periphery of the photosensitive drum 1, a brush member 12 as a paper powder collecting member and a discharging device 11 as a discharging means. Further, the process cartridge 9 includes a memory 15 as a non-volatile storing means.

Further, the process cartridge 9 includes a toner amount sensor 20 as a developer amount detecting means. The charging roller 2, the developing roller 4 as a developer carrying member provided in the developing device 8, and the brush member 12 are disposed in contact with a surface (outer peripheral surface) of the photosensitive drum 1. The process cartridge 9 is constituted so that the process cartridge 9 can be easily detachably mountable integrally to the apparatus main assembly M threshold a mounting means (not shown) such as a mounting guide or a positioning member provided to the apparatus main assembly M and the process cartridge 9.

Further, the image forming apparatus 100 includes the transfer roller 13 which is a roller-shaped transfer member as a transfer means, an exposure device 10 as an exposure means, and a fixing device 14 as a fixing means. The transfer roller 13 is disposed in contact with the surface of the photosensitive drum 1.

Further, the image forming apparatus 100 includes a controller 200 managing control of entirety of the image forming apparatus 100 and includes an operation panel 60 and the like. The operation panel 60 is constituted by including a display portion for displaying information to an operator such as a user or a service person by control of controller 200, and an input portion for inputting information to the controller 200 in response to an operation of the operator, and the like.

### <Image Forming Operation>

Next, an image forming operation of the image forming apparatus 100 will be described. To the photosensitive drum 1, a driving force is transmitted from a driving motor (not shown) as a driving source constituting a driving means provide in the apparatus main assembly M, so that the photosensitive drum 1 is rotationally driven in an arrow R1 direction (counterclockwise direction) in FIG. 1 at a predetermined process speed. Here, the process speed corresponds to a peripheral speed (surface movement speed), and the process speed in the embodiment 1 is 140 rpm.

The charging roller 2 forms a charging portion in contact with the surface of the photosensitive drum 1 at a predetermined contact pressure. To the charging roller 2, a predetermined charging voltage (charging bias) which is a DC voltage is applied from a charging voltage applying circuit (not shown) as a charging voltage applying means provided in the apparatus main assembly M.

By this, the charging roller 2 electrically charges the surface of the photosensitive drum 1 uniformly to a predetermined polarity (negative in the embodiment 1) and to a predetermined potential. In the embodiment 1, the charging voltage of −1400 V is applied to the charging roller 2 so that a surface potential (pre-exposure potential VD) of the photosensitive drum 1 becomes −800 V. Incidentally, in the embodiment 1, the DC voltage was used as the charging voltage, but is not limited thereto, and an oscillating voltage in the form of superposition of the DC voltage and an AC voltage may be used as the charging voltage.

The uniformly charged surface of the photosensitive drum 1 is subjected to scanning exposure by being irradiated with laser light on the basis of image information by the exposure device 10, so that an electrostatic latent image (electrostatic image) is formed on the photosensitive drum 1. In the embodiment 1, the exposure device 10 is constituted by a scanner unit. The image information inputted from an external provide (not shown), such as a personal computer or the like connected to the image forming apparatus 100, to the image forming apparatus 100 is converted into a time-series electric digital image signal by a video controller 206 provided in the image forming apparatus 100. The exposure device 10 is controlled by the controller 200 and emits laser light modulated correspondingly to the time-series electric digital image signal, so that the surface of the photosensitive drum 1 is scanned and exposed to light. By this, the electrostatic latent image corresponding to the image information is formed on the photosensitive drum 1. In the embodiment 1, the exposure device 10 irradiates the surface of the photosensitive drum 1 with the laser light at a light quantity of 0.45 J/cm² so that a post-exposure potential VL of the surface of the photosensitive drum 1 becomes −100 V.

The electrostatic latent image formed on the photosensitive drum 1 is developed (visualized) by being supplied with toner 3 as a developer by the developing device 8, so that a toner image (toner picture, developer image) is formed. The developing device 8 includes the developing roller 4. The developing roller 4 forms a developing portion by contacting the surface of the photosensitive drum 1 at a predetermined contact pressure. On the developing roller 4, a toner layer by the toner 3 charged to a predetermined polarity (negative in the embodiment 1) is formed. To the developing roller 4, a predetermined developing voltage (developing bias) which is a DC voltage is applied from a developing voltage applying circuit (not shown) as a developing voltage applying means provided in the apparatus main assembly M. By this, in the developing portion, the toner 3 is deposited on the electrostatic latent image on the photosensitive drum 1. By this, the toner image is formed on the photosensitive drum 1. In the embodiment 1, to the developing roller 4, the developing voltage of −400 V is applied. In the embodiment 1, on an exposed portion (image portion) on the photosensitive drum 1 lowered in absolute value of the potential by being exposed after being uniformly charged, the toner 3 charged to the same polarity (negative in the embodiment 1) as a charge polarity of the photosensitive drum 1 (reverse development type). In the embodiment 1, a normal charge polarity of the toner 3 which is a principal charge polarity of the toner 3 during development is the negative polarity.

The transfer roller 13 forms a transfer portion in contact with the photosensitive drum 1 at a predetermined contact pressure. The toner image formed on the photosensitive drum 1 is transferred in the transfer portion onto a recording material P nipped and conveyed by the photosensitive drum 1 and the transfer roller 13. During the transfer, to the transfer roller 13, a predetermined transfer voltage (transfer bias) which is a DC voltage is applied from a transfer voltage applying circuit (not shown) as a transfer voltage applying means. In the embodiment 1, to the transfer roller 13, the transfer voltage of +1500 V is applied.

The recording material P (transfer material, recording medium, sheet) is supplied from a feeding portion 30 toward the transfer portion. The feeding portion 30 is constituted by including a cassette 31 as a recording material accommodating portion, a feeding roller 32 as a feeding member, and the like.

The recording material P accommodated in the cassette 31 is separated one by one by the feeding roller 32 or the like and is fed from the cassette 31. This recording material P is conveyed to the transfer portion so as to be timed to the toner image on the photosensitive drum 1 by a conveying roller 50 (registration roller) as a conveying member.

The recording material P on which the toner image is transferred is conveyed to the fixing device 14 as a fixing means. The fixing device 14 fixes (melts, sticks) the toner image on the recording material P under application of heat and pressure to the recording material P. The recording material P on which the toner image is fixed is discharged (outputted) onto a tray 40 as a discharging portion provided to an outside of the apparatus main assembly M.

On the other hand, toner (transfer residual toner) remaining on the photosensitive drum 1 without being transferred onto the recording material P in a transfer step is removed from the surface of the photosensitive drum 1 in the following manner. The surface of the photosensitive drum 1 after the transfer step enters the charging portion after being discharged by the discharging device 11 (discharging lamp) so that the surface potential becomes 0 V. The transfer residual toner remaining on the photosensitive drum 1 includes toner charged to a positive polarity and toner which is charged to the negative polarity but which does not have a sufficient electric charge in mixture. The transfer residual toner is charged to the negative polarity by electric discharge in the charging portion. The transfer residual toner charged to the negative polarity in the charging portion reaches the developing portion with rotation of the photosensitive drum 1.

Here, on the surface of the photosensitive drum 1 reached the developing portion, the electrostatic latent image depending on the image information is formed. The transfer residual toner deposited on a non-exposed portion (non-image portion) on the photosensitive drum 1 is moved from the photosensitive drum 1 to the developing roller 4 by a potential difference between the pre-exposure potential VD and the developing voltage on the photosensitive drum 1 in the developing portion, and is collected in a developing chamber 8b of the developing device 8. Incidentally, the toner collected in the developing chamber 8b is used again in the image formation. On the other hand, the transfer residual toner deposited on the exposed portion (image portion) on the photosensitive drum 1 is not moved from the photosensitive drum 1 to the developing roller 4 in the developing portion and constitutes the toner image in cooperation with the toner moved from the developing roller 4 to the photosensitive drum 1. Then, the toner is transferred onto the recording material P in the transfer portion and is removed from the photosensitive drum 1.

Further, the brush member 12 as the paper powder collecting member is provided for removing paper powder fibers which are deposited from the recording material P to the photosensitive drum 1 in the transfer step and which generated from the recording material P. The brush member 12 is disposed in contact with the photosensitive drum 1 on a side downstream of the transfer portion and upstream of the charging portion with respect to the rotational direction of the photosensitive drum 1. The brush member 12 rubs the surface of the photosensitive drum 1 with rotation of the photosensitive drum 1, and catches and removes the paper powder fibers from the surface of the photosensitive drum 1.

### <Detailed Constitution of Developing Device 8>

Next, a detailed constitution of the developing device 8 in the image forming apparatus 100 of the embodiment 1 will be described. In the embodiment 1, the developing device 8 is a one-component contact developing device using a non-magnetic one-component developer (toner) as the developer. The developing device 8 includes a developing container 80 (frame) constituted by including the developing chamber 8b as a developing member accommodating portion and a toner accommodating chamber 8a as an accommodating portion for accommodating the developer. The developing chamber 8b and the toner accommodating chamber 8a communicate with each other threshold an opening. In the developing chamber 8b, the developing roller 4 as the developer carrying member (developing member) for supplying the toner from the toner accommodating chamber 8a to the photosensitive drum 1 and the supplying roller 5 as the supplying member for supplying the toner 3 to the developing roller 4 are provided. Further, the developing chamber 8b is provided with a developing blade 6 as a regulating member for regulating an amount of the toner on the developing roller 4 while imparting an electric charge of a predetermined polarity to the toner 3 on the developing roller 4. The developing roller 4 is disposed rotatably at an opening of the developing chamber 8b (developing container 80), and conveys the toner 3 from an inside to an outside of the developing chamber 8b (developing container 80) by being rotated while carrying the toner 3. In the toner accommodating chamber 8a, the toner 3 as the developer is accommodated. Further, the toner accommodating chamber 8a is provided with a stirring member 7 for conveying the toner 3 from the toner accommodating chamber 8a toward the developing chamber 8b while stirring the toner 3 in the toner accommodating chamber 8a.

Incidentally, in the embodiment 1, the developing device 8 uses the contact development type in which the image bearing member and the developer carrying member are disposed in contact with each other, but the present invention is not limited thereto. The developing device 8 may also use a two-component development type using a two-component developer or a non-contact development type in which the image bearing member and the developer carrying member are disposed opposed to each other with a predetermined gap.

In the embodiment 1, the developing roller 4 is constituted by coating an outer periphery of a core metal of 6 mm in diameter with a base layer of a silicone rubber and a surface layer of an urethane rubber in this order so as to provide an outer diameter of 15 mm. Further, in the embodiment 1, an electric resistance value of the developing roller 4 is 1×10⁴ to 1×10¹²Ω.

Further, in the embodiment 1, the supplying roller 5 is an electroconductive elastic sponge roller constituted by forming a foamed member layer on an outer periphery of a core metal of 6 mm in diameter. Further, in the embodiment 1, the supplying roller 5 is 1×10⁴ to 1×10⁸Ω in electric resistance value and 200 gf in hardness. Incidentally, the hardness of the supplying roller 5 is a value obtained by measuring a load in the case where a flat plate of 50 mm in longitudinal width is caused to enter the supplying roller 5 by 1 mm from a surface of the supplying roller 5.

In the embodiment 1, the developing blade 6 is a 0.1 mm-thick SUS metal plate having a predetermined length in each of a longitudinal direction extending along a rotational axis direction of the developing roller 4 and a widthwise direction substantially perpendicular to the longitudinal direction. This developing blade 6 is disposed in contact with the developing roller 4 along the longitudinal direction at a side surface thereof in the neighborhood of a free end thereof with respect to the widthwise direction so that the free end is directed toward an upstream side of the rotational direction of the developing roller 4. In the embodiment 1, as the developing blade 6, a blade prepared by cutting an end (free end) portion of the SUS metal plate from a contact surface side to the developing roller 4 was used. The end portion of the developing blade 6 is bent in a cutting direction by the cutting, and a bent amount of the end of the developing blade 6 corresponding to curvature radius R is 0.02 mm.

Motion of the toner 3 in the developing device 8 during drive will be described. To the developing device 8, a driving force is transmitted from a driving motor (not shown) as a driving source constituting a driving means provided in the apparatus main assembly M. By this, the developing roller 4, the supplying roller 5, and the stirring member 7 are rotated in an arrow R2 direction (clockwise direction), an arrow R3 direction (clockwise direction), and an arrow R4 direction (counterclockwise direction), respectively, in FIG. 1. Incidentally, the driving source for the photosensitive drum 1 and the respective rotatable members (the developing roller 4, the supplying roller 5, the stirring member 7) may be commonalized. The stirring member 7 in the toner accommodating chamber 8a is rotated, so that the toner 3 in the toner accommodating chamber 8a is stirred and conveyed toward the supplying roller 5 in the developing chamber 8b. The toner 3 held in the foamed member layer of the supplying roller 5 is sent to a contact portion with the developing roller by rotation of the supplying roller 5. Then, the toner 3 reached the contact portion is rubbed by the surface of the developing roller 4 and the surface of the supplying roller 5 which move in different directions in this contact portion, so that a part thereof is deposited on the surface of the developing roller 4. Incidentally, in the embodiment 1, a constitution in which the developing roller 4 and the supplying roller 5 are rotated in the opposite directions in the contact portion was described as an example, but for example, a constitution in which the supplying roller 5 is rotated in a direction (counterclockwise direction) opposite to the arrow R3 direction and thus is moved in the same direction as the rotational direction of the developing roller 4 in the contact portion may be employed.

The toner 3 deposited on the surface of the developing roller 4 is sent to a contact portion with the developing blade 6 with rotation of the developing roller 4. The developing blade 6 forms a uniform thin layer of the toner 3 by regulating an amount of the toner 3 deposited on the surface of the developing roller 4, and triboelectrically charges the toner 3. The toner 3 formed in the thin layer is sent to a contact portion with the photosensitive drum 1 with rotation of the developing roller 4 and is used for developing the electrostatic image formed on the photosensitive drum 1. The toner 3 remaining on the surface of the developing roller 4 without being used for the development is conveyed to the contact portion with the supplying roller 5, and is removed from the surface of the developing roller 4 by the supplying roller 5. The removed toner 3 is sent into the toner accommodating chamber 8a, and then is stirred and mixed with the toner 3 in the toner accommodating chamber 8a.

### <Toner Supply Constitution>

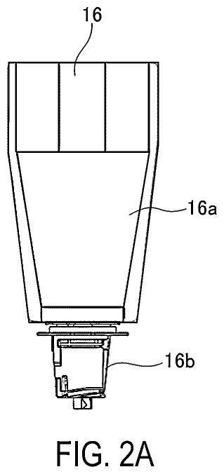

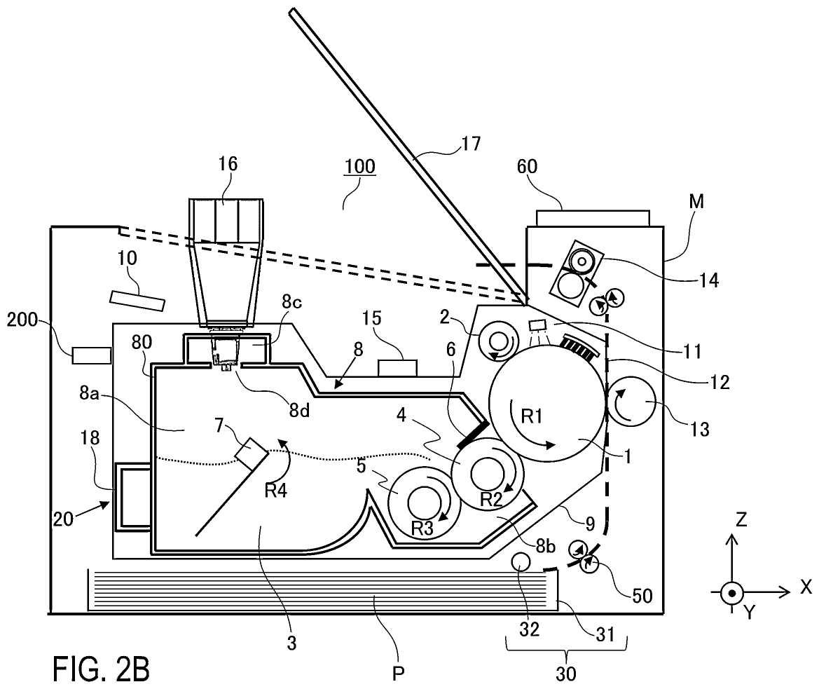

Next, a toner supply constitution of the toner toward the developing container 80 of the developing device 8 in the embodiment 1 will be described. To the developing container 80, a toner pack 16 which is a supply container for supplying the toner to the toner accommodating chamber 8a is detachably mountable. FIG. 2A is a schematic front view of the toner pack 16 as the toner supply sensor in the embodiment 1. Further, FIG. 2B is a schematic sectional view showing a state in which the toner pack 16 is mounted to the developing container 80 of the developing device 8.

As shown in FIG. 1 and FIG. 2B, the developing container 8 is provided with a supply projection portion 8c. The supply projection portion 8c is formed so that an inside thereof is a hollow portion and communicates with the toner accommodating chamber 8a threshold a supply opening 8d. At an upper portion of the apparatus main assembly M, a top cover 17 is provided so as to be openable and closable. Incidentally, an upper surface of the top cover 17 constitutes the above-described tray 40.

As shown in FIG. 2A, in the embodiment 1, the toner pack 16 is constituted by including a plastic bag 16a which is easily deformable and a connecting portion 16b provided at one end portion of the bag 16a. An inside of the bag 16a and an inside of the connecting portion 16b communicate with each other. As shown in FIG. 2B, the image forming apparatus 100 is constituted so that the supply projection portion 8c exposed to the outside by opening the top cover 17 upward. To an end portion of the supply projection portion 8c, the toner pack 16 is a mountable, and when the toner pack 16 is mounted to the supply projection portion 8c, the toner is capable of being supplied from the toner pack 16 to the toner accommodating chamber 8a. The toner pack 16 is connected to the supply projection portion 8c by the connecting portion 16b in a state in which the top cover 17 is opened, so that the toner pack 16 is mounted to the supply projection portion 8c in a state in which at least a part thereof on an end portion side of the bag 16a opposite from the connecting portion 16b is exposed to the outside of the image forming apparatus 100. Incidentally, in an example of FIG. 1 and FIG. 2B, a constitution in which the top cover 17 which is an openable (closable) member for exposing the supply projection portion 8a to the outside also functions as the tray 40 is described as an example, but the present invention is not limited to this constitution. For example, a constitution in which the top cover 17 is capable of opening only a portion above the supply projection portion 8c may be employed.

When the toner pack 16 is mounted to the supply projection portion 8c, the inside of the toner pack 16 (the bag 16a, the connecting portion 16b) and the inside of the supply projection portion 8c communicate with each other. Then, the toner accommodated in the toner pack 16 is discharged into the supply projection portion 8c threshold an opening (not shown) provided in the connecting portion 16b of the toner pack 16, so that this toner is supplied from the supply projection portion 8c into the toner accommodating chamber 8a threshold the supply opening 8d.

Incidentally, in the embodiment 1, the toner supply container is constituted by the plastic bag which is easily deformable, but the present invention is not limited thereto. For example, the toner supply container may also be constituted by including a bottle container having a substantially conical shape or a substantially cylindrical shape. Further, for example, the toner supply container may be constituted by including a container formed of paper. Further, a method for discharging the toner 3 from the toner supply container may suitably be a method in which when the toner supply container is the toner pack 16 as in the embodiment 1 or the paper container, the operator squeezes the toner pack 16 or the paper container with his (her) fingers, and may suitably be a method in which when the toner supply container is the bottle container, the operator discharges the toner while vibrating the bottle container by tapping or striking the bottle container. Further, in order to discharge the toner 3 from the bottle container, the bottle container may be provided with a discharging mechanism.

The discharging mechanism may have a constitution in which the discharging mechanism engages with a driving mechanism provided in the apparatus main assembly M of the image forming apparatus 100 and receives drive from the driving mechanism.

Further, in order to prevent leakage of the toner from the toner supply container, the toner supply container may be provided with a shutter member of a rotation type or a slide type. Further, the shutter member may have a constitution such that the shutter member is broken by being mounted to the supply opening 8d of the developing device 8, or may have a removable lid structure such as a seal.

### <Toner Amount Sensor>t

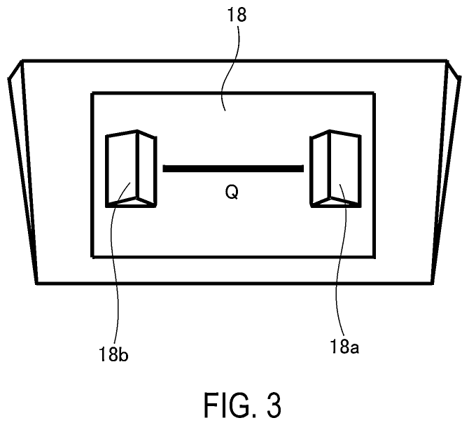

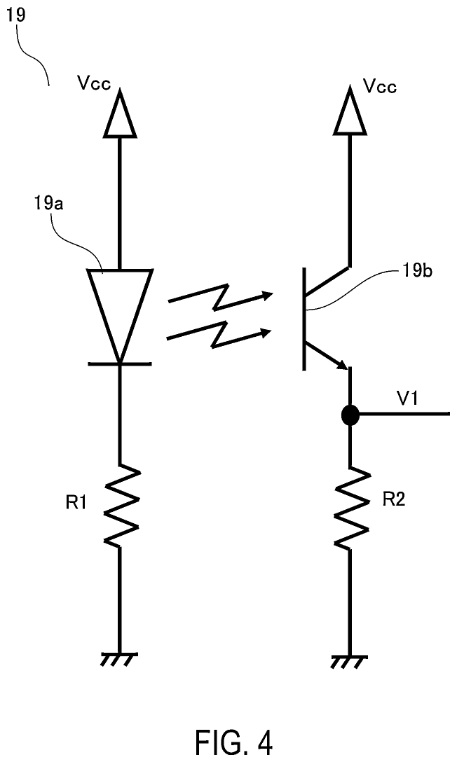

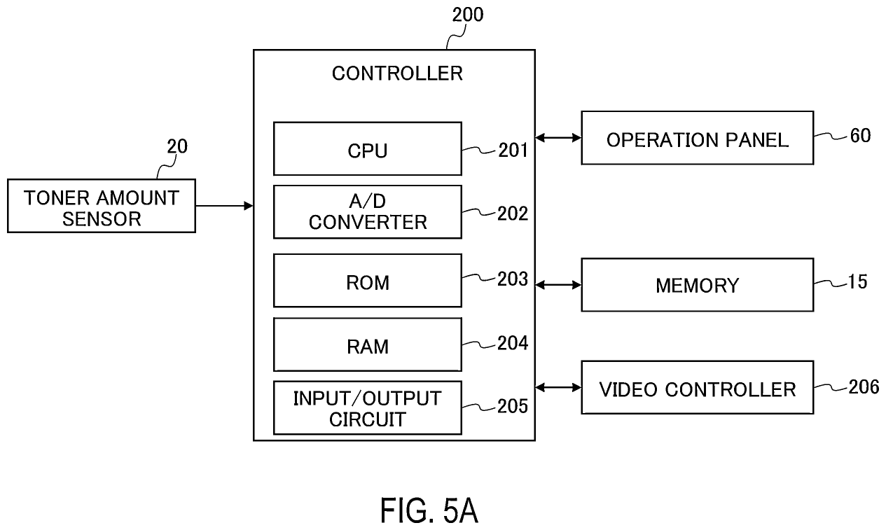

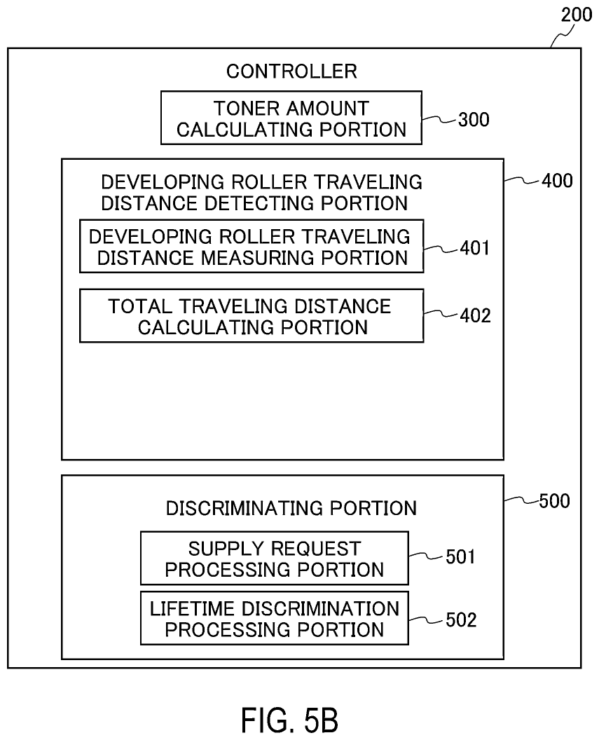

Next, the toner amount sensor 20 as the developer amount detecting means for detecting the toner amount (remaining toner amount) of the toner in the developing device 8 in the embodiment 1 will be described. FIG. 3 is a schematic front view of a light guiding member 18 constituting the toner amount sensor 20 in the embodiment 1. Further, FIG. 4 is a circuit view of a sensor portion 19 constituting the toner amount sensor 20 in the embodiment 1. Further, FIGS. 5A and 5B are schematic black diagrams each showing a control system of the image forming apparatus 100 of the embodiment 1, in which FIG. 5A schematically shows the controller 200 and FIG. 5B schematically shows function blocks in the controller 200.

As shown in FIG. 1, the developing device 8 is provided with the light guiding member 18 constituting the toner amount sensor 20. As shown in FIG. 3, the light guiding member 18 includes a light-emitting-side light guiding portion 18a and a light-receiving-side light guiding portion 18b. The light-emitting-side light guiding portion 18a guides light, emitted from a light emitting element 19a of a sensor portion 19 described later, to an inside of the developing container 80. The light-receiving-side light guiding portion 18b guides the last, passed through the light-emitting-side light guiding portion 18a and a spatial optical path Q inside the developing container 80, to a light receiving element 19b of the sensor portion 19 described later.

Further, as shown in FIG. 1, the developing device 8 is provided with the sensor portion 19 constituting the toner amount sensor 20. As shown in FIG. 4, the sensor portion 19 includes the light emitting element 19a, the light receiving element 19b, and a substrate (not shown) on which the light emitting element 19a and the light receiving element 19b are provided. In the embodiment 1, an LED is used as the light emitting element 19a, and a phototransistor is used as the light receiving element 19b. This phototransistor is placed in an ON state by the light from the LED. Further, the substrate is provided with a cable connector (not shown), and the sensor portion 19 is connected by a cable threshold the cable connector to the controller 200 described later provided in the apparatus main assembly M of the image forming apparatus 100.

Next, an arrangement of the toner amount sensor 20 in the embodiment 1 will be described. The toner amount sensor 20 (the light guiding member 18, the sensor portion 19) is disposed on a side surface of the toner accommodating chamber 8a of the developing container 80. In the embodiment 1, the toner amount sensor 20 (the light guiding member 18, the sensor portion 19) is provided at a central portion of the toner accommodating chamber 8a (developing container 80) with respect to the Y direction. A longitudinal direction of the toner accommodating chamber 8a is parallel to the Y direction. The toner inside the toner accommodating chamber 8a is localized in the longitudinal direction of the toner accommodating chamber 8a in some instances, but at the central portion of the toner accommodating chamber 8a with respect to the longitudinal direction, a degree of localization of the toner is small. For that reason, the toner amount sensor 20 (the light guiding member 18, the sensor portion 19) is provide at the central portion of the toner accommodating chamber 8a with respect to the longitudinal direction, so that it is possible to detect the toner amount suppressed in the influence of the localization of the toner.

Next, a detecting method of the toner amount by the toner amount sensor 20 will be described. In FIG. 4, a switch (not shown) is provided between the light emitting element 19a and a power source voltage Vcc, and is turned on (ON state), so that the light emitting element 19a is put in a conduction state. On the other hand, a switch (not shown) is also provided between the light receiving element 19b and a power source voltage Vcc, and is turned on (ON state), so that the light receiving element 19b is put in a conduction state, and thus a current flows depending on a light quantity detected by the light receiving element 19b. To the light emitting element 19a, the power source voltage Vcc and a current limiting resistor R1 are connected, so that the light emitting element 19a emits light by a current determined by the current limiting resistor R1. The light emitted from the light emitting element 19a passes through the spatial optical path Q, and is received by the light receiving element 19b. To a collector terminal of the light receiving element 19b, the power source voltage Vcc is connected, and to an emitter terminal of the light receiving element 19b, a detection resistor R2 is connected. The light receiving element 19b which is the phototransistor receives the light emitted from the light emitting element 19a and outputs a signal (current) depending on the received light quantity. This signal is converted into a voltage V1 by the detection resistor R2 and is inputted to an A/D converting portion 202, described later, of the controller 200. That is, the light receiving element 19b changes an output value depending on the toner amount of the toner accommodated in the toner accommodating chamber 8a. To the toner amount sensor 20, electric power is supplied from a power source provided to the apparatus main assembly M.

A toner amount calculating portion 300, described later, of the controller 200 discriminates whether or not the light receiving element receives the light from the light emitting element 19a, on the basis of a voltage level which is inputted to the controller 200 by the toner amount sensor 20 and which is then converted into a digital signal by the A/D converting portion 202. Then, the toner amount calculating portion 300 calculates a length of a time in which the toner amount sensor 20 detected the light when the toner 3 in the developing container 80 is stirred by the stirring member 7 for a predetermined time. In a ROM 203, described later, of the controller 200, toner amount discrimination information for discriminating (calculating, predicting, estimating) the toner amount is stored in advance as a table showing a relationship between the above-described time and the toner amount. Then, the toner amount calculating portion 300 calculates the toner amount of the toner in the developing container 80 on the basis of the voltage level inputted to the controller 200 by the toner amount sensor 20 and converted by the A/D converting portion 202, and the information of the above-described table.

The toner amount calculating portion 300 causes the memory 15 to store the toner amount of the toner in the developing container 80 calculated on the basis of a detection result by the toner amount sensor 20. Incidentally, in the embodiment 1, in the memory 15, a remaining toner amount T of the toner accommodated in the toner accommodating chamber 8a when the developing device 8 (process cartridge 9) is a new article (initial use, unused state) is stored in advance.

In the embodiment 1, when the image forming operation is executed, a remaining toner amount T′ last detected by the toner amount sensor 20 at the time of an end of the image forming operation is calculated by the toner amount calculating portion 300. Then, in the case where the calculated remaining toner amount T′ is smaller than the remaining toner amount T stored in the memory 15, the toner amount calculating portion 300 updates the remaining toner amount T stored in the memory 15 to the remaining toner amount T′ (causes the memory 15 to store the remaining toner amount as T=T′). Further, when a supplying operation for supplying the toner from the toner pack 16 to the developing device 8 is executed, a remaining toner amount T″ detected by the toner amount sensor 20 during the supplying operation is calculated by the toner amount calculating portion 300. Then, in the case where the calculated remaining toner amount T″ is larger than the remaining toner amount T stored in the memory 15, the toner amount calculating portion 300 updates the remaining toner amount T stored in the memory 15 to the remaining toner amount T″ (causes the memory 15 to store the remaining toner amount as T=T″). By this, it is possible to prevent erroneous detection such that the toner amount is increased during the image forming operation and erroneous detection such that the toner amount is decreased during the supplying operation.

In the embodiment 1, a method in which the toner amount is calculated from the time in which the light is detected was used, but a method in which the b amount toner is calculated from pixel count information of the image, a method in which the toner amount is calculated from electrostatic capacity, and the like method may be used. The toner amount calculating method is not limited to these method if the method is capable of calculating the toner amount.

### <Control Constitution>

As shown in FIG. 5A, in the apparatus main assembly M of the image forming apparatus 100, the controller 200 as the control means is provided. The controller 200 is constituted by including a CPU 201 as an arithmetic processing means which is a central element, for performing arithmetic processing, the A/D converting portion (converter) 202, the ROM 203 and a RAM 204 which are as a storing means (storing medium), an input/output circuit 205, and the like. The A/D converting portion 202 converts an analog signal, inputted to the controller 200, into the digital signal. In the ROM 203, a control program, a data table acquired in advance, and the like are stored. In the RAM 204, information inputted to the controller 200, detected information, a processing result, and the like are stored. The input/output circuit 205 controls input and output of signals between the controller 200 and devices connected to the controller 200.

To the controller 200, respective portions (various driving devices, various power sources, various sensors, and the like) of the image forming apparatus 100 are connected. The controller 200 controls operations of the respective portions by establishing bidirectional communication to the respective portions of the image forming apparatus 100. The controller 200 executes the image forming operation by controlling the respective portions of the image forming apparatus 100 on the basis of signals (start signal, image signal) inputted from an external device (not shown) such as a personal computer in response to an operation by an operator.

Further, as shown in FIG. 5B, in the embodiment 1, the controller 200 includes the toner amount calculating portion 300. The toner amount calculating portion 300 calculates the toner amount (remaining toner amount) of the toner in the developing container 80 on the basis of a detection result by the toner amount sensor as described above. In the embodiment 1, the toner amount calculating portion 300 is realized by execution of a program stored in the ROM 203 by the CPU 201.

Further, as shown in FIG. 5B, in the embodiment 1, the controller 200 includes a developing roller traveling distance detecting portion 400 as a developing roller traveling distance detecting means. The developing roller traveling distance detecting portion 400 includes a developing roller traveling distance measuring portion 401 for counting a traveling distance of the developing roller 4 as development information relating to a surface in movement distance of the developing roller 4. In the following, herein, “traveling of the developing roller” is defined as that it means rotation of the developing roller, and “traveling distance of the developing roller” is defined as that it means how long the surface of the developing roller travels by rotation. Accordingly, the “traveling distance of the developing roller” can also be said as a “surface movement distance of the developing roller” or a “number of rotations of the developing roller”. The developing roller traveling distance detecting portion 400 includes a total traveling distance calculating portion 402 for calculating, as development drive information, a cumulative movement distance obtained by integrating the traveling distance of the developing roller 4 from a start of use (initial use). In the embodiment 1, the developing roller traveling distance detecting portion 400 (the developing roller traveling distance measuring portion 401, the total traveling distance calculating portion 402) is realized by executing the program stored in the ROM 203 by the CPU 201.

The controller 200 includes a discriminating portion 500 comprising a supply requirement (request) processing portion 501 and a lifetime discrimination processing portion 502. The supply requirement processing portion 501 causes the operation panel 60 to display information prompting an operator to perform the supplying operation. Further, the supply requirement processing portion 501 detects (recognizes) execution of the supplying operation on the basis of a signal inputted from the operation panel 60 in response to the operation by the operator. Further, the supply requirement processing portion 501 may detect the execution of the supplying operation on the basis of opening/closing of the top cover 17 or the detection result of the toner amount. In the embodiment 1, the supply requirement processing portion 501 is realized by execution of the program, stored in the ROM 203, by the CPU 201.

The lifetime discrimination processing portion 502 causes the operation panel 60 to display information indicating lifetime notification to the operator. The lifetime notification is information notification for notifying the operator that there is a possibility that an appropriate image cannot be printed even when the supply of the toner is executed. The lifetime discrimination processing portion 502 detects (recognizes) execution of exchange of the process cartridge 9 on the basis of a signal inputted from the operation panel 60 in response to the operation by the operator. Further, the lifetime discrimination processing portion 502 may detect the exchange of the process cartridge 9 on the basis of opening/closing of the openable/closable member (not shown) provided to the apparatus main assembly M for exchanging the process cartridge 9. Incidentally, the top cover 17 may also function as the openable/closable member for exchanging the process cartridge 9. That is, a constitution in which the process cartridge 9 is capable of being exchanged in a state in which the top cover 17 is opened as shown in FIG. 2B may be employed. Further, the exchange of the process cartridge 9 may be detected on the basis of information communication between the controller 200 of the apparatus main assembly M and the memory 15 of the process cartridge 9. In the embodiment 1, the lifetime discrimination processing portion 502 is realized by execution of the program, stored in the ROM 203, by the CPU 201.

The controller 200 providing notification prompting the user to supply the toner and providing notification to the effect that the developing device 8 reached an end of a lifetime thereof, threshold the operation panel 60 on the basis of processing results by the supply requirement processing portion 501 and the lifetime discrimination processing portion 502 functions as a notifying means.

Incidentally, in the embodiment 1, the process cartridge 9 is provided with the memory 15 which is a non-volatile storing means. The controller 200 is capable of reading information from the memory 15 of the process cartridge 9 and writing the information into the memory 15 of the process cartridge 9. In the memory 15, as information on calculation of use status (use history) of the developing device 8 and on supply requirement notification, information on the toner amount, information of a threshold on the toner amount, information on the traveling distance of the developing roller 4, information of a threshold on the traveling distance of the developing roller 4, and the like information are stored.

By this, even in the case where ON/OFF of the power source of the apparatus main assembly M and mounting and demounting of the process cartridge 9 are performed, on the basis of the above-described information stored in the memory 15, it is possible to appropriately carrying out control in conformity with the process cartridge 9 (the developing device 8). However, the present invention is not limited thereto, and the information stored in the memory 15 in the embodiment 1 may be stored in a memory provide to, for example, the controller 200 or the like of the apparatus main assembly M.

### <Developing Roller Traveling Distance Detection Control.

Next, developing roller traveling distance detection control for detecting the traveling distance of the developing roller 4 in the embodiment 1 will be described. In the embodiment 1, a total traveling distance TotalL which is a value corresponding to a cumulative traveling distance added every traveling distance (predetermined developing roller traveling distance) L of the developing roller 4 in a predetermined section and obtained by integrating the traveling distance of the developing roller 4 from initial use to the present. The traveling distance of the developing roller 4 in the predetermined section is, for example, a surface movement distance of the developing roller 4 from a start to an end of the image forming operation.

### <Supply Requirement/Lifetime Discrimination Threshold>

Next, a supply requirement discrimination threshold and a lifetime discrimination threshold in the embodiment 1 will be described.

In the embodiment 1, the operator is capable of executing the supplying operation at an arbitrary timing. However, when a state in which the toner is not supplied into the developing container 80 is continued, for example, a problem leading to an image defect such as filming arises. The filming is a phenomenon such that the developer and an external additive added to the developer are deposited on the developing roller, so that a lowering in surface roughness of the developing roller and an increase in electric resistance value of the developing roller are caused. Due to this filming, not only an appropriate image density cannot be obtained, but also a fog, density non-uniformity of a half-tone image, and the like occur.

Therefore, the image forming apparatus 100 of the embodiment 1 executes supply requirement notification prompting the operator to perform the supplying operation for supplying the toner from the toner pack 16 to the developing device 8 on the basis of the remaining toner amount T of the toner in the developing container 80 and the total traveling distance TotalL as the development drive information. The remaining toner amount T is remaining amount information which is information on an amount of the toner accommodated in the toner accommodating chamber 8a. The total traveling distance TotalL is the development drive information which is information on the surface movement distance of the developing roller 4.

In the embodiment 1, the supply requirement processing portion 501 and the lifetime discrimination processing portion 502 make discrimination by using three thresholds (remaining toner amount threshold Tth, total traveling distance threshold TotalLth, and supply execution traveling distance threshold L1th) in the following manner.

The supply requirement processing portion 501 calculates a printable remaining toner amount Tj based on the remaining toner amount (total toner amount) T of the toner in the developing container 80 with use of the remaining toner amount threshold Tth as a supply discrimination threshold by the following formula (1).

$$Tj = T - Th \qquad formula ( 1 )$$

The lifetime discrimination processing portion 502 calculates a printable total traveling distance TotalLj based on the traveling distance (total traveling distance TotalL) in which the developing roller 4 is driven from a start of use of the developing container 80 to the present. The printable total traveling distance TotalLj is calculated with use of the total traveling distance threshold TotalLth (traveling distance corresponding to two-sheet intermittent 25,000 pages in the embodiment 1) as a lifetime discrimination threshold by the following formula (2).

$$TotalLj = TotalLth - TotalL \qquad formula ( 2 )$$

That is, the printable total traveling distance TotalLj is a value showing a printable traveling distance from this point of time to arrival at an end of the lifetime.

The supply requirement processing portion 501 calculates a pre-supply execution travelable distance L1j based on the traveling distance (total traveling distance TotalL) in which the developing roller 4 is driven from the start of use of the developing container 80 to the present. The pre-supply execution travelable distance L1j is calculated with use of the supply execution traveling distance L1th as a supply discrimination threshold by the following formula (3).

$$L 1 j = L 1 th - TotalL \qquad formula ( 3 )$$

That is, the pre-supply execution travelable distance L1j is a value showing a printable traveling distance from this point of time (TotalL) to the supply requirement (L1th).

Incidentally, as the supply execution traveling distance L1th, a plurality of values (for example, 10 km, 20 km, and the like) may be set in advance.

In the embodiment 1, the remaining toner amount threshold Tth, the total traveling distance threshold TotalLth, and the supply execution traveling distance threshold L1th are set in advance and are stored in the memory 15. Each of these thresholds is set in advance as a value at which there is a possibility that an appropriate image cannot be formed due to a decrease in remaining toner amount or an increase in traveling distance of the developing roller 4.

Further, the supply requirement processing portion 501 and the lifetime discrimination processing portion 502 cause the memory 15 to store the printable remaining toner amount Tj, the printable total traveling distance TotalLj, and the pre-supply execution travelable distance L1j, which are calculated.

Then, in the case where Tj≤0 or L1j≤ is satisfied, there is a possibility that an appropriate image cannot be printed, and therefore, the supply requirement processing portion 501 executes supply requirement notification prompting the operator to perform the supplying operation. Tj<0 is the case where the remaining toner amount T becomes a predetermined remaining toner amount threshold Tth or less (remaining amount threshold or less). L1j≤0 is the case where the total traveling distance TotalL (cumulative movement distance) becomes the supply execution traveling distance threshold L1th or more (first supply discrimination threshold or more). Further, in the case where Total Lj≤0 is satisfied, there is a possibility that the appropriate image cannot be printed even when the supply of the toner is executed, and therefore, the lifetime discrimination processing portion 502 executes lifetime notification to the operator. Total Lj≤0 is the case where the total traveling distance TotalL (cumulative movement distance) becomes the total traveling distance threshold TotalLth or more (lifetime discrimination threshold or more).

In the embodiment 1, the supply requirement processing portion 501 and the lifetime discrimination processing portion 502 cause the operation panel 60 to display, as supply requirement notification or lifetime notification, information prompting the operator to perform the supplying operation or information notifying the operator that the developing device 8 reached an end of the lifetime thereof. Further, on the basis of a signal inputted from the operation panel 60 in response to the operation by the operator, the supply requirement processing portion 501 detects that the supplying operation was executed. This signal is, for example, a signal or the like inputted from the operation panel 60 in response to an operation of a button or the like of the operating portion by the operator when the supplying operation is completed. Further, when the supply requirement processing portion 501 detects that the supplying operation was executed, the supply requirement processing portion 501 drives the developing device 8 and acquires information on the remaining toner amount after the supplying operation and a traveling distance of the developing roller 4.

### <Supply Requirement/Lifetime Notification Sequence of Developing Device>

The image forming apparatus 100 of the embodiment 1 executes the supply requirement notification and the lifetime notification to the operator on the basis of the remaining toner amount of the toner in the developing container 80, the printable total traveling distance TotalL, and the pre-supply execution travelable distance L1j. The supply requirement notification is notification prompting the user to perform the supplying operation for supplying the toner from the toner pack 16 to the developing device 8.

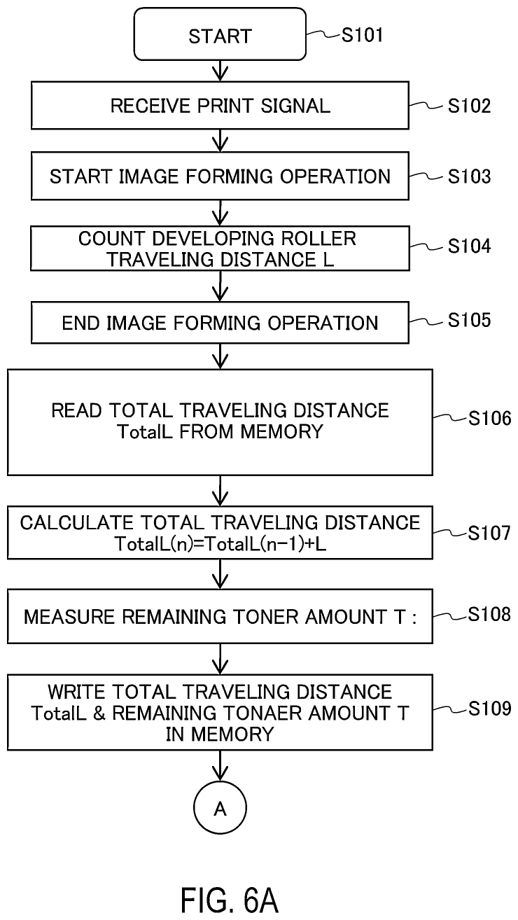

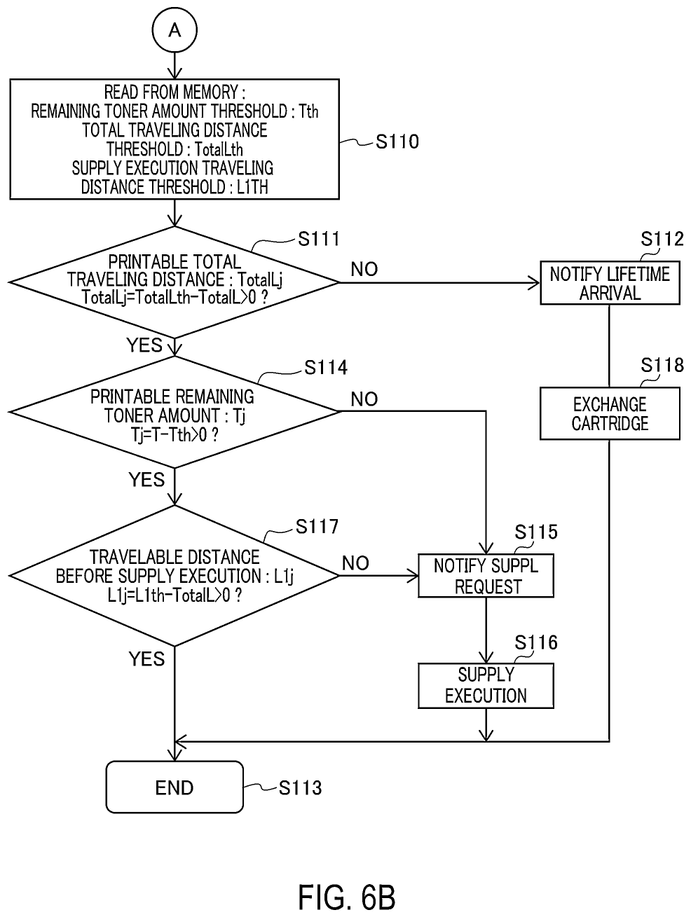

FIGS. 6A and 6B are flowcharts showing a supply timing of the toner to the developing device 8 or a sequence for discriminating the lifetime of the developing device 8 in the embodiment 1. The controller 200 performs respective processing shown in the flowcharts of FIGS. 6A and 6B and detects a supply requirement timing of the toner to the developing device 8 and the lifetime of the developing device 8, and then notifies the user of a result thereof.

First, from a start (S101), a print signal is sent to the image forming apparatus 100 (S102). Then, the image forming operation is started (S103), the developing roller traveling distance L during the image forming operation is counted (S104), and then the image forming operation is ended (S105).

Next, from the memory 15, the total traveling distance TotalL to the present (until immediately before execution of the image forming operation of S103 to S105) until the present is read (S106).

Then, to a total traveling distance TotalL(n−1) to the present read in S106, the traveling distance L in which the developing roller travels in a current image forming operation is added, so that a latest total traveling distance TotalL(n) is calculated by the following formula (4) (S107).

$$TotalL ( n ) = TotalL ( n - 1 ) + L \qquad formula ( 4 )$$

Incidentally, in the above-described explanation, processing for updating the total traveling distance to the present after the image forming operation is ended was described as an example, but processing in which the total traveling distance is updated in real time during execution of the image forming operation may be performed.

Next, the remaining toner amount T is measured (S108).

Then, TotalL(n) calculated in S107 is written as the total traveling distance TotalL updated to a latest value, in the memory 15, and the remaining toner amount measured in S108 is written as a latest remaining toner amount T in the memory 15 (S109).

Next, from the memory 15, the remaining toner amount threshold Tth, the total traveling distance threshold TotalLth, and the supply execution traveling distance threshold LIth are read (S110).

First, the printable total traveling distance TotalLj is calculated from the above-described formula (2), and whether or not a relationship of TotalLj>0 is satisfied is discriminated (S111).

In the case where TotalLj>0 is not satisfied (S111: NO), the printable traveling distance does not remain, and therefore, lifetime arrival is notified (S112), and exchange of the process cartridge 9 is executed (S118), and then the processing goes to “END” (S113).

In the case where TotalLj>0 is satisfied (S111: YES), the printable remaining toner amount Tj is calculated from the above-described formula (1), and whether or not a relationship of Tj>0 is satisfied is discriminated (S114).

In the case where Tj>0 is not satisfied (S114: NO), printable toner does not remain, and therefore, toner supply requirement is notified (S115). Thereafter, the supplying operation is executed (S116), and then the processing goes to “END” (S113).

In the case where Tj>0 is satisfied (S114: YES), the pre-supply execution travelable distance L1j is calculated from the above-described formula (3), and whether or not a relationship of L1j>0 is satisfied is discriminated (S117).

In the case where L1j>0 is not satisfied (S117: NO), there is no remaining travelable distance until supply execution, and therefore, supply requirement is notified (S115). Thereafter, the supplying operation is executed (S116), and the processing goes to “END” (S113).

In the case where L1j>0 is satisfied (S117: YES), the remaining travelable distance remains, and therefore, the processing goes to “END” (S113).

By executing this series of the flowcharts, in the embodiment 1, before the fog due to the filming occurs, it is possible to notify the user of the supplying operation requirement of the toner to the developing device 8 8 and the lifetime of the developing device 8. A method of the lifetime notification may be a method of notifying the user of arrival at an end of the lifetime by using the operation panel 60 or the like or may be a method in which the image forming operation is stopped.

Incidentally, a lifetime advance notice threshold may be determined before the total traveling distance reaches the total traveling distance threshold TotalLth. For example, in the case where the lifetime advance notice threshold is set to 90% of the total traveling threshold TotalLth, at a point of time when the remaining lifetime of the developing device 8 reaches 10% of the end of the lifetime, it becomes possible to notify the user of warning that the end of the lifetime of the developing device 8 is close in this embodiment. For that reason, the user is capable of preparing for exchanging the developing device 8 in advance.

Further, in the embodiment 1, the developing device 8 is provided with the memory 15, but the present invention is not limited thereto, and a memory provided in the apparatus main assembly M of the image forming apparatus 100.

### <Low Print Ratio Printing>

Here, an image forming operation with a low print ratio will be described. The print ratio can be defined as a ratio of a print area (area of a portion where the toner is placed in an image formable region of the recording material) to a sheet area (area of the image formable region of the recording material). As typical image formation with the low print ratio, for example, it is possible to cite image formation such that a toner consumption amount is small due to that the image is constituted by only a text or a line. Further, even when the contents of the image to be formed are the same, between a small-size sheet and a large-size sheet, the small-size sheet is smaller in print amount 8 toner consumption amount). Accordingly, as another definition of the print ratio, when a print amount in the case where a whole black image (solid back image) is formed on one sheet of a predetermined size (for example, a latter size) is taken as 100%, the print ratio can be defined as a ratio to this print amount. In this definition, when the contents of the image are the same, image formation with a lower print ratio is made with a smaller sheet size.

As a cause of an image defect such as the fog or the like, it is possible to cite deterioration of the toner, and one of factors of the toner deterioration, it is possible to cite flowing of the toner in the developing container during the image forming operation. The toner in the developing container 80 is repetitively rubbed by the supplying roller 5 and the developing blade 6 during the image forming operation and is gradually deteriorated due to occurrences of external additive liberation from and embedding in a toner base material, deformation of the toner base material itself, and the like. The toner subjected to development during the image forming operation is a part of the toner in the developing container 80, so that the toner in a large amount remains in the developing container 80 without being subjected to development. Such remaining of the toner becomes conspicuous in the case where the image forming operation is continued at the low print ratio. With a lower print ratio-image formation, the toner in a larger amount in the developing container 80 stagnates in the developing container 80 without being consumed, and in a period until the toner supply to the developing container 80 is executed, many image forming operations are repeated. The toner deterioration progresses by continuous retention of the toner in the developing container 80 without being subjected to development every image forming operation. Accordingly, with the lower print ratio-image formation, before the toner in the developing container 80 is consumed to a predetermined amount in which the toner supply is prompted to the user, a degree of the toner deterioration in the developing container 80 is more progressed, so that the image defect becomes liable to occur before the toner supply is executed. That is, the image defect due to the toner deterioration in the developing container 80 is liable to occur in the case where the image is mainly formed of the text or the line or in the case where the size of the recording material is small.

In the embodiment 1, even in the case where the low print ratio-image forming operation is repeated, the pre-supply execution travelable distance L1j reaches 0 before the toner amount of the toner in the developing container 80 reaches the remaining toner amount threshold Tth, so that toner supply requirement is notified and then the toner supply is executed. For that reason, fresh toner can be supplied before the toner deterioration and the consumption of the developing roller 4 progress due to that the traveling distance of the developing roller 4 becomes excessively long in a state in which the toner consumption amount is small. By this, it is possible to suppress the occurrence of the image defect such as the fog due to the toner deterioration and the consumption of the developing roller 4.

### Evaluation Experiment of Embodiment 1

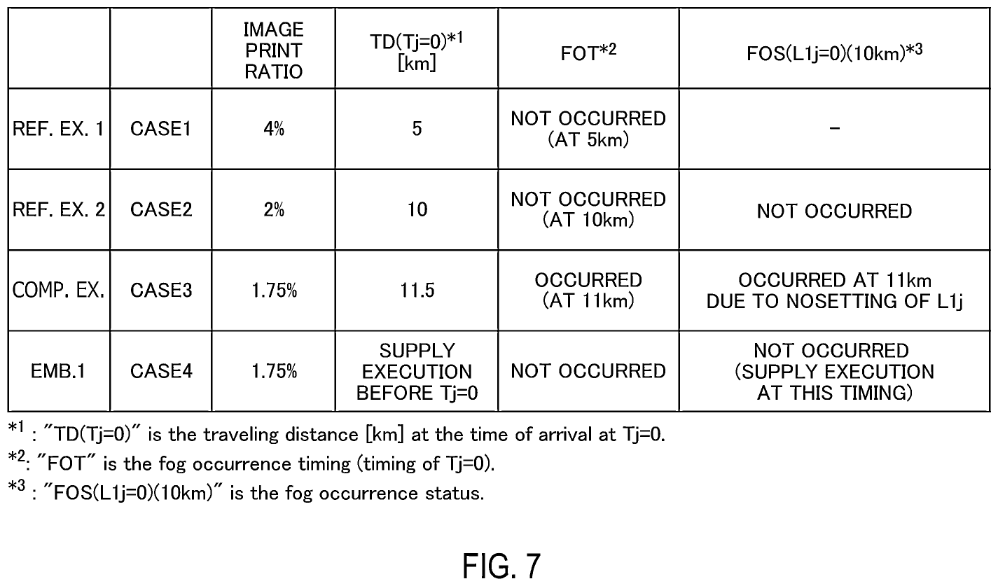

On 25,000 sheets of recording materials, images were formed by using image data for an experiment. Lateral line patterns of three types of 4%, 2%, and 1.75% in image print ratio were used. Further, the supply execution traveling distance threshold L1th was set to 10 km, and the total traveling distance threshold TotalLth was set to 25 km. In FIG. 7, a result when the experiment was conducted was shown. Each of four cases 1 to 4 will be described.

### Case 1 (Reference Example 1): High Print Ratio Printing (Image Print Ratio: 4%)

Due to high print ratio printing, a timing when the toner consumption progresses and the printable remaining toner amount Tj becomes 0 became a point of time of the total traveling distance TotalL=5 km. The toner is consumed before degrees of the toner deterioration and the consumption of the developing roller progress, so that there was no occurrence of the fog and a toner supply timing has come. Further, the supplying operation is performed, so that the deteriorated toner in the developing device is replaced with new (fresh) toner. By this, the influences by the toner deterioration and the consumption of the developing roller are alleviated, so that the image forming apparatus was subsequently able to be used until the total traveling distance threshold TotalLth=25 km with no occurrence of the fog.

### Case 2 (Reference Example 2): Low Print Ratio Printing (Image Print Ratio: 2%)

The print ratio was half of the print ratio in the case 1, and therefore, the timing when the printable remaining toner amount Tj becomes 0 between a point of time of the total traveling distance TotalL=10 km which is twice the total traveling distance TotalL in the case 1. Compared with the case 1, the toner consumption amount is small, and therefore, although the consumption degree of the developing roller progresses, there is no occurrence of the fog, and the toner supply timing has come. Further, similarly as in the case 1, the supplying operation is performed, so that the deteriorated toner in the developing device is replaced with the new toner. By this, the influences by the toner deterioration and the consumption of the developing roller are alleviated, so that the image forming apparatus was subsequently able to be used until the total traveling distance threshold TotalLth=25 km with no occurrence of the fog.

### Case 3 (Comparison Example): Low Print Ratio Printing (Image Print Ratio: 1.75%)

The print ratio was somewhat lowered from the print ratio in the case 2, and therefore, the timing when the printable remaining toner amount Tj becomes 0 became a point of time of the total traveling distance Total L=11.5 km. The toner consumption amount is further smaller than the toner consumption amount in the case 2, and therefore, the degrees of the toner deterioration and the consumption of the developing roller further progress, so that the fog occurred at a point of time of the total traveling distance TotalL=11 km before the timing of Tj=0.

### Case 4 (Embodiment 1): Low Print Ratio Printing (Image Print Ratio: 1.75%)+L1j is Set

In a case similar to the case 3, by setting the supply execution traveling distance threshold L1th=10 km, the supplying operation was performed before the total traveling distance reaches the total traveling distance in which the fog occurs. The deteriorated toner in the developing device 8 is replaced with the new toner, whereby the influence by the toner deterioration and the consumption of the developing roller are alleviated, so that the image forming apparatus was subsequently able to be used until the total traveling state threshold TotalLth=25 km with no occurrence of the fog.

In a type such that the toner is collectively supplied as in the embodiment 1, a fresh developer is supplied by the supply, so that it turned out that the filming state of the developing roller 4 was considerably improved. As in the embodiment 1, by executing the supplying operation at an appropriate timing, it becomes possible to subsequently printing the images with no occurrence of the fog.

As described above, the pre-supply execution travelable distance L1j is set, so that the supply is executed before the fog occurs, and thus the image forming apparatus 100 can be subsequently used with no occurrence of the fog.

In the embodiment 1, as the supply execution traveling distance threshold L1th, only one value (10 km) was set, but a plurality of thresholds may be set. For example, setting is made so as to be a first threshold L1th1=10 km and a second threshold Lth2=19 km, and at first, in S117, the supply is executed by discrimination using the first threshold L1th1 (10 km). Thereafter, the threshold used in S117 is changed to the second threshold L1th2 (19 km), and subsequently, the processing may also be carried out in accordance with the flowcharts of FIGS. 6A and 6B.

In an embodiment 2, a portion overlapping with the portion in the embodiment 1 will be omitted from description, and a portion peculiar to the embodiment 2 will be described.

In the embodiment 2, in addition to the embodiment 1, a supply interval traveling distance RefillL, a toner use amount T1, and a pre-supply execution supply interval travelable distance L2j are set. The supply interval traveling distance RefillL (supply interval movement distance) is a distance obtained by integrating a traveling distance (movement distance) of the developing roller 4 from after the toner supply in a predetermined section of the surface of the developing roller 4. The toner use amount is a use amount of the toner from an initial stage or from immediately after the supply of the toner. The pre-supply execution supply interval travelable distance L2j is a printable traveling distance from the present time to supply requirement. By this, in the case where the toner use amount is small and the supply interval traveling distance is long, it becomes possible to early notification the supply requirement. By this, it becomes possible to suppress the occurrence of the fog while suppressing the toner deterioration and the consumption of the developing roller 4 in the developing device 8.

### <Control Constitution>

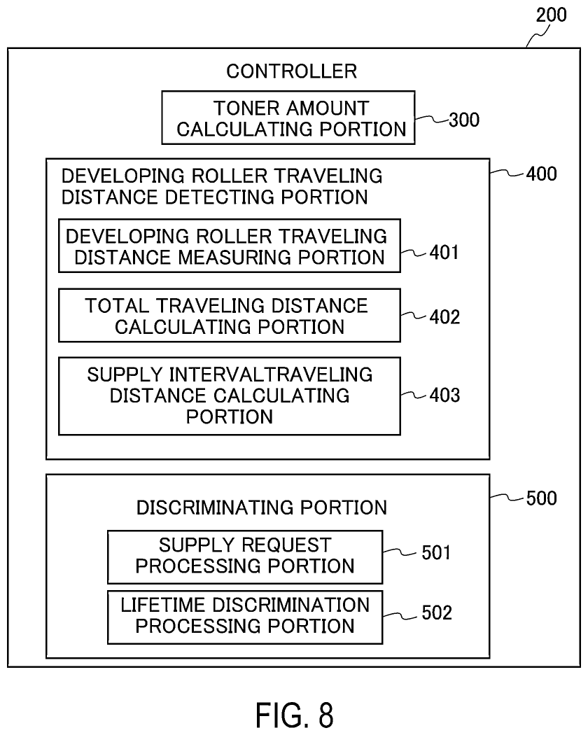

In FIG. 8, a block diagram used in the embodiment 2 is shown. A portion overlapping with the portion in the embodiment 1 will be omitted from description. In the embodiment 2, the developing roller traveling distance detecting portion 400 includes, in addition to the developing roller traveling distance measuring portion 401 and the total traveling distance calculating portion 402, a supply interval traveling distance calculating portion 403. The supply interval traveling distance calculating portion 403 calculates a traveling distance from a start of use or from immediately after execution of the supplying operation until a subsequent supplying operation is executed.

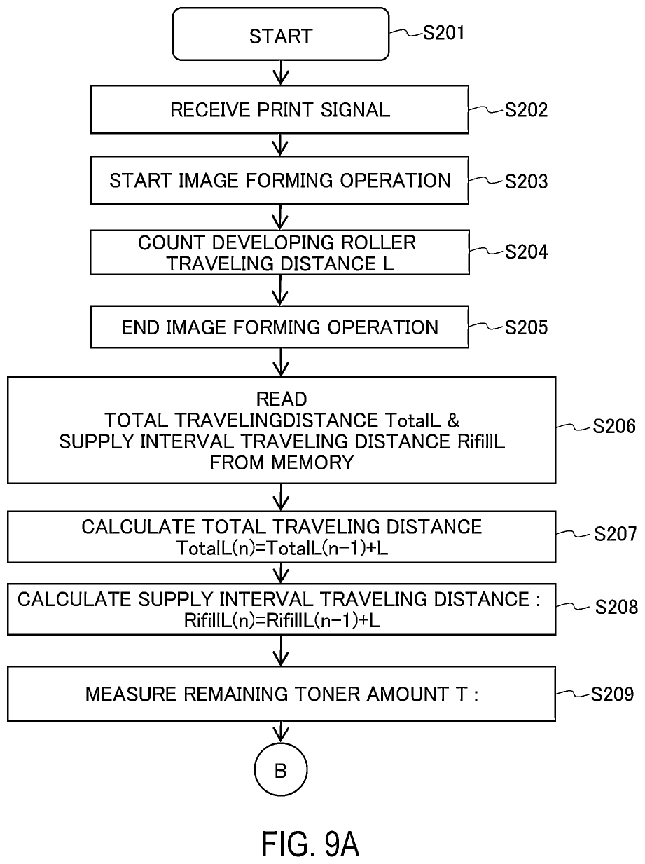

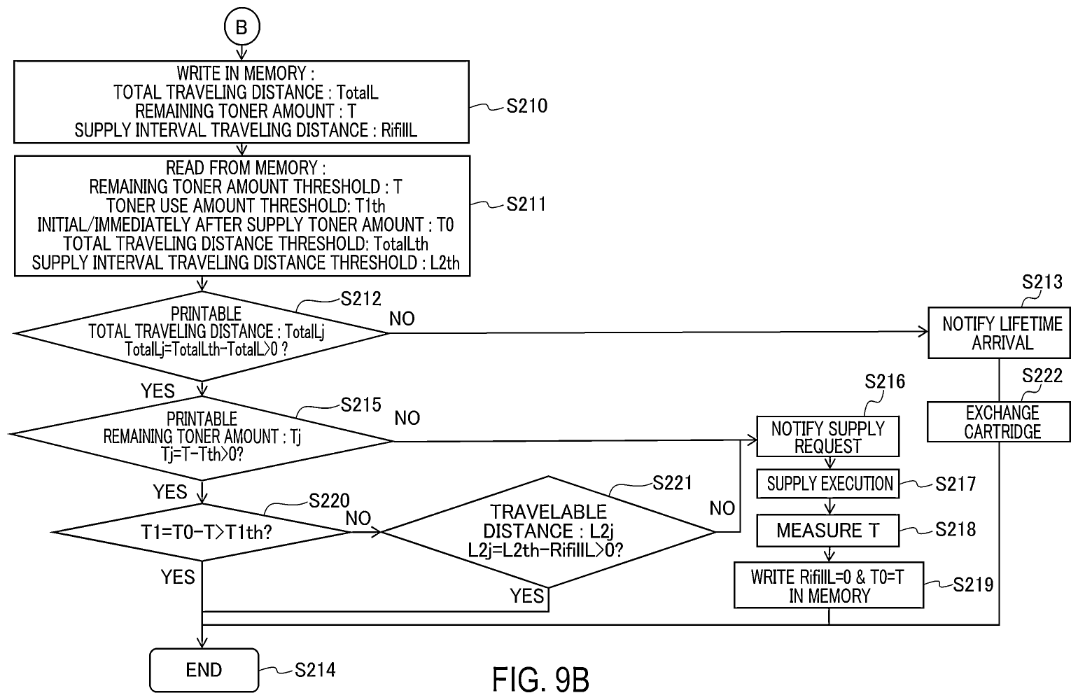

FIGS. 9A and 9B are flowcharts showing a supply timing of the toner to the developing device 8 or a sequence for discriminating the lifetime of the developing device 8 in the embodiment 2. The controller 200 performs respective processing shown in the flowcharts of FIGS. 9A and 9B and detects a supply requirement timing of the toner to the developing device 8 and the lifetime of the developing device 8, and then notifies the user of a result thereof.

First, from a start (S201), a print signal is sent to the image forming apparatus 100 (S202). Then, the image forming operation is started (S203), the developing roller traveling distance L during the image forming operation is counted (S204), and then the image forming operation is ended (S205).

Next, from the memory 15, the total traveling distance TotalL to the present (until immediately before execution of the image forming operation of S203 to S205 until the present and the supply interval traveling distance RefillL until the present are read (S206).

Then, a total traveling distance to the present read in S206 is represented by TotalL(n−1), and the traveling distance L in which the developing roller traveled in a current image forming operation is added thereto, so that a latest total traveling distance TotalL(n) is calculated (S207). A calculation formula of the latest total traveling distance TotalL(n) is the formula (4) used in the embodiment 1.

Further, the supply interval traveling distance until the present read in S206 is represented by RefillL(n−1), and a traveling distance L in a current image forming operation is added thereto, so that a latest supply interval traveling distance Refill(n) is calculated (S208). The latest supply interval traveling distance RefillL(n) is calculated by the following formula (5).

$$RefillL ( n ) = Refill ( n - 1 ) + L \qquad formula ( 5 )$$

Next, the remaining toner amount T is measured (S209).

Then, TotalL(n) calculated in S207 is written, in the memory 15, as a total traveling distance TotalL updated to a latest value. Further, RefillL(n) calculated in S208 is written, in the memory 15, as a supply interval traveling distance RefillL updated to a latest value. Further, the remaining toner amount measured in S209 is written as a latest remaining toner amount T in the memory 15 (S210).

Next, from the memory 15, the remaining toner amount threshold Tth, a toner use amount threshold T1th, an initial/immediately after traveling distance threshold T0, the total traveling distance threshold TotalLth, and the supply execution supply interval traveling distance threshold L1th are read (S211). s regards the initial/immediately after remaining toner amount T0, in the case where the supplying operation is not executed once, a toner amount of the toner filled during a new state is stored, and after the supplying operation is executed, a remaining toner amount immediately after the supplying operation is actually measured, and the initial/immediately after remaining toner amount T0 is updated by this measured value.

First, the printable total traveling distance TotalLj is calculated from the formula (2) described in the embodiment 1, and whether or not a relationship of TotalLj>0 is satisfied is discriminated (S212).

In the case where TotalLj>0 is not satisfied (S212: NO), the printable traveling distance does not remain, and therefore, lifetime arrival is notified (S213), and exchange of the process cartridge 9 is executed (S222), and then the processing goes to “END” (S214).

In the case where TotalLj>0 is satisfied (S212: YES), the printable remaining toner amount Tj is calculated from the formula (1) described in the embodiment 1, and whether or not a relationship of Tj>0 is satisfied is discriminated (S215).

In the case where Tj>0 is not satisfied (S215: NO), printable toner does not remain, and therefore, toner supply requirement is notified (S216). Thereafter, the supplying operation is executed (S217), and then the remaining toner amount T of the toner in the developing container immediately after the supply is measured (S218). Then, the supply interval traveling distance and the initial/immediately after remaining toner amount in the memory 15 are updated to RefillL=0 and T0=T, respectively (S219), and the processing goes to “END” (S214).

In the case where Tj>0 is satisfied (S215: YES), the toner use amount from the initial stage or from immediately after supply is calculated by the following formula (6), and then is compared with the toner use amount threshold T1th, so that whether or not the toner use amount is small is discriminated (S220).

$$T = T 0 - T \qquad formula ( 6 )$$

In the case where T1>T1th is satisfied (S220: Yes), i.e., in the case where the toner use amount T1 from the initial stage or from immediately after the supply is large, discrimination that toner deterioration and developing roller filming do not occur is made, and the processing goes to “END” (S214).

In the case where T1>T1th is not satisfied (S220: NO), i.e., in the case where the toner use amount T1 from the initial stage or from immediately after the supply is small, a pre-supply execution supply interval travelable distance L2j is calculated from the following formula (7), and whether or not there is a remaining printable traveling distance is discriminated (S221).

$$L 2 j = L 2 th - RefillL \qquad formula ( 7 )$$

That is, the pre-supply execution supply interval travelable distance L2j is a value showing a printable supply interval traveling distance from the present time (RefillL) to the supply requirement (L2th).

In the case where L2j>0 is not satisfied (S221: NO), from the viewpoints of the toner deterioration and the developing roller filming, supply of the new toner is needed, and therefore, supply requirement of the toner is notified (S216).

Thereafter, the supplying operation is executed (S217), and the remaining toner amount T in the developing container immediately after the supply is measured (S218). Then, the supply interval traveling distance and the initial/immediately after remaining toner amount in the memory 15 are updated to RefillL=0 and T0=T, respectively (S219), and the processing goes to “END” (S214).

In the case where L2j>0 is satisfied (S221: YES), the remaining toner amount is sufficient and the supply interval traveling distance does not excessively progress, and therefore, discrimination that the toner deterioration and the developing roller filming do not occur is made, and the processing goes to “END” (S214).

By executing this series of the flowcharts, in the case where the remaining toner amount T becomes a predetermined remaining toner amount threshold Tth or less (remaining amount threshold or less), supply requirement notification is provided. Further, the requirement notification is provided in the case where the toner use amount T1 from execution of the last supply is the predetermined threshold T1th or less and the supply interval traveling distance RefillL (supply interval movement distance) becomes the supply execution supply interval traveling distance threshold L2th or more (second supply discrimination threshold or more). In the embodiment 2, before the fog due to the filming occurs, it is possible to notify the user of the supplying operation requirement of the toner to the developing device 8 8 and the lifetime of the developing device 8. A method of the lifetime notification may be a method of notifying the user of arrival at an end of the lifetime by the operation panel 60 or the like or may be a method in which the image forming operation is stopped.

Further, in the embodiment 2, an example in which only one value is used as the toner use amount threshold T1th for discriminating the toner use amount T1 from the initial stage or from immediately after the supply was described, but a plurality of toner use amount thresholds may be used. Then, the supply interval traveling distance RefillL may be discriminated by using a plurality of supply execution supply interval traveling distance thresholds L2th depending on a discrimination result based on the plurality of toner use amount thresholds. By this, it becomes possible to make lifetime settings corresponding to various print ratio patterns.

Further, in the embodiment 2, depending on a result of discrimination of the toner use amount T1 (S220), a supply execution timing is changed (S221). However, the print ratio and the toner consumption amount per unit traveling distance are calculated, and it is possible to set a different supply execution supply interval traveling distance threshold L2th every print ratio zone or every toner consumption amount per unit traveling distance. For example, at a print ratio of 0 to 0.5%, the threshold can be set to 4 km, and at a print ratio of 0.6 to 1%, the threshold can be set to 6 km.

Further, in the embodiment 2, an example in which depending on a result of the discrimination (S220) of the toner use amount, the supply execution discrimination (S221) based on the pre-supply supply interval travelable distance L2j is made was described. However, the supply execution discrimination may also be made depending on a discrimination result of a toner use amount (low print ratio toner use amount) in printing in which the print ratio is lower than a print ratio determined in advance. For example, in the case where the low print ratio toner use amount exceeds a low print ratio toner use amount threshold, by making the discrimination of S221, in the case of an operator who principally performs the printing at the low print ratio.

Incidentally, in the case where the supply is not made even once, the supply interval traveling distance RefillL is equal to the total traveling distance TotalL.

### Evaluation Experiment of Embodiment 2

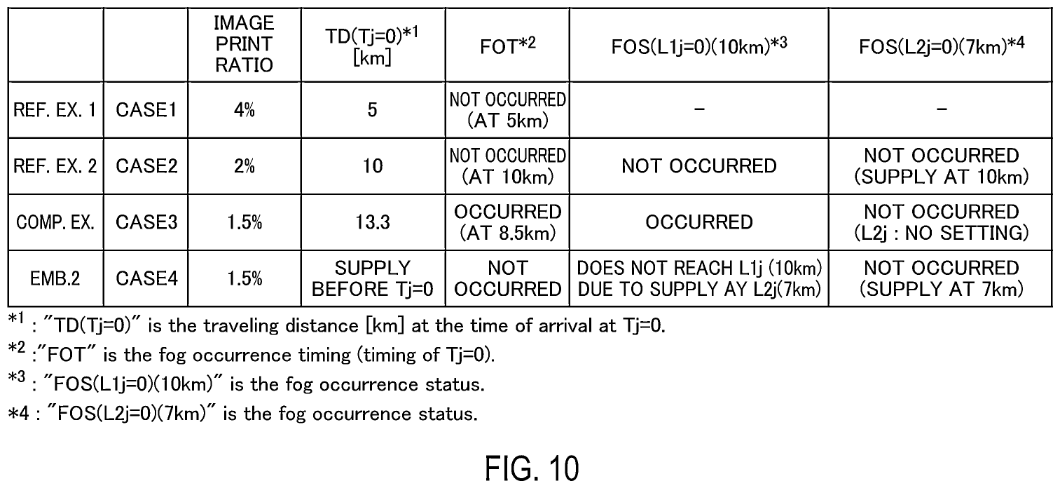

On 30,000 sheets of recording materials, images were formed by using image data for an experiment. Lateral line patterns of three types of 4%, 2%, and 1.5% in image print ratio were used. Further, the toner use amount threshold T1th was set to 30 g, the supply execution supply interval traveling distance threshold L2th was set to 7 km, and the total traveling distance threshold TotalLth was set to 30 km. In FIG. 10, a result when the experiment was conducted was shown. Each of four cases 1 to 4 will be described.

### Case 1 (Reference Example 1): High Print Ratio Printing (Image Print Ratio: 4%)

Due to high print ratio printing, a timing when the toner consumption progresses and the printable remaining toner amount Tj becomes 0 became a point of time of the total traveling distance TotalL=5 km. The toner is consumed before degrees of the toner deterioration and the consumption of the developing roller progress, so that there was no occurrence of the fog and a toner supply timing has come. Further, the supplying operation is performed every 5 km such that the total traveling distance TotalL is 5 km, 10 km, . . . , so that the deteriorated toner in the developing device is replaced with new (fresh) toner. By this, the influences by the toner deterioration and the consumption of the developing roller are alleviated, so that the image forming apparatus was subsequently able to be used until the total traveling distance threshold TotalLth=30 km with no occurrence of the fog.

### Case 2 (Reference Example 2): Low Print Ratio Printing (Image Print Ratio: 2%)

The print ratio was half of the print ratio in the case 1, and therefore, the timing when the printable remaining toner amount Tj becomes 0 between a point of time of the total traveling distance TotalL=10 km which is twice the total traveling distance TotalL in the case 1. Compared with the case 1, the toner consumption amount is small, and therefore, although the consumption degree of the developing roller progresses, there is no occurrence of the fog, and the toner supply timing has come. Further, the supplying operation is performed every 10 km such that the total traveling distance TotalL is 10 km, 20 km, . . . , so that the deteriorated toner in the developing device is replaced with the new toner. By this, the influences by the toner deterioration and the consumption of the developing roller are alleviated, so that the image forming apparatus was subsequently able to be used until the total traveling distance threshold TotalLth=30 km with no occurrence of the fog.

### Case 3 (Comparison Example): Low Print Ratio Printing (Image Print Ratio: 1.5%)

The print ratio was somewhat lowered from the print ratio in the case 2, and therefore, the timing when the printable remaining toner amount Tj becomes 0 became a point of time of the total traveling distance Total L=13.5 km. The toner consumption amount is further smaller than the toner consumption amount in the case 2, and therefore, the degrees of the toner deterioration and the consumption of the developing roller further progress, so that the fog occurred at a point of time of the total traveling distance TotalL=8.5 km before the timing of Tj=0.

### Case 4 (Embodiment 2): Low Print Ratio Printing (Image Print Ratio: 1.5%)+(T1, L2j) is Set

In a case similar to the case 3, setting of the toner use amount threshold T1th=30 g, and the supply execution supply interval traveling distance threshold L2th=7 km, was made. By this, a use status such that although the remaining toner amount T remains so as to permit the printing (the toner use amount T1 is small), the supply interval traveling distance RefillL becomes long can be made discriminable. Even in such a use status in which the low print ratio printing is principally executed, in the case of the embodiment 2, by executing the supplying operation every supply interval traveling distance RefillL=7 km (L2th), the deteriorated toner in the developing device 8 is replaced with the new toner. By this, the influences by the toner deterioration and the consumption of the developing roller are alleviated, so that the image forming apparatus was subsequently able to be used until the total traveling state threshold TotalLth=30 km with no occurrence of the fog.

As described above, the toner use amount T1 and the pre-supply execution supply interval travelable distance L2j are set, so that the supply is executed before the fog occurs, and thus the image forming apparatus 100 can be subsequently used with no occurrence of the fog.

In the embodiment 2, an example in which as the toner use amount threshold T1th, one value (for example, 30 g) was used was described, but a plurality of values are set, and for each of toner use amount thresholds, different settings for the supply execution supply interval traveling threshold L2th may be made. For example, the second toner use amount threshold T1th2=15 g is set, and the second supply execution supply interval traveling distance threshold L2th2=4 km is set.

By this, for a user further low in print ratio, the supplying operation is executed before the degrees of the toner deterioration and the consumption of the developing roller progress, so that the image forming apparatus can be subsequently used with no occurrence of the fog.

Further, in the embodiment 2, an example in which as the supply execution supply interval traveling distance threshold L2th, one value (for example, 7 km) was set was described, but a plurality of values may be set. For example, setting is made such that depending on the number of times of supply, a threshold used for discrimination in second supply is 6.8 km and a threshold use for discrimination in third supply is 6.7 km and subsequently to first supply, the processing may also be carried out in accordance with the flowcharts of FIGS. 6A and 6B.

In an embodiment 3, in addition to parameters described in the embodiment 1, calculation of a corrected total traveling distance and a corrected supply interval traveling distance with use of a correction coefficient for correcting the traveling distance of the developing roller 4 is a feature.

In an embodiment 3, a portion overlapping with the portion in the embodiment 1 will be omitted from description, and a portion peculiar to the embodiment 3 will be described.

### <Control Constitution>

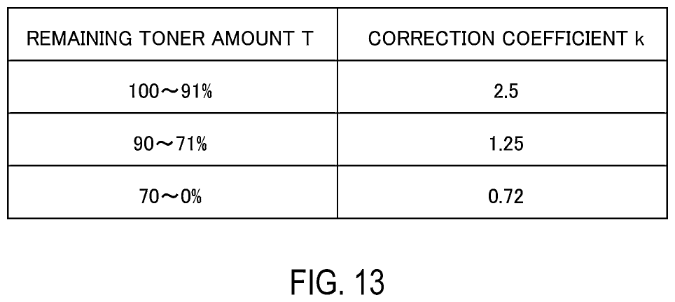

In FIG. 13, a block diagram used in the embodiment 3 is shown. A portion overlapping the portions in the embodiments 1 and 2 will be omitted from description. In the embodiment 3, the developing roller traveling distance detecting portion 400 includes a corrected supply interval traveling distance calculating portion 404. The corrected supply interval traveling distance calculating portion 404 is a portion in which the supply interval traveling distance is corrected with use of a correction coefficient and then is integrated. Incidentally, the correction coefficient will be described later.

In the embodiment 3, in addition to the parameters described in the embodiment 1, by using the correction coefficient for correcting the traveling distance of the developing roller 4, the corrected total traveling distance and the corrected supply interval traveling distance are calculated. By this, in the case where the toner use amount is small and the traveling distance from after the supply is long, large correction is made relative to the traveling distance, so that it becomes possible to early notification the supply requirement. By this, it becomes possible to suppress the occurrence of the fog while suppressing the toner deterioration and the consumption of the developing roller 4 in the developing device 8.

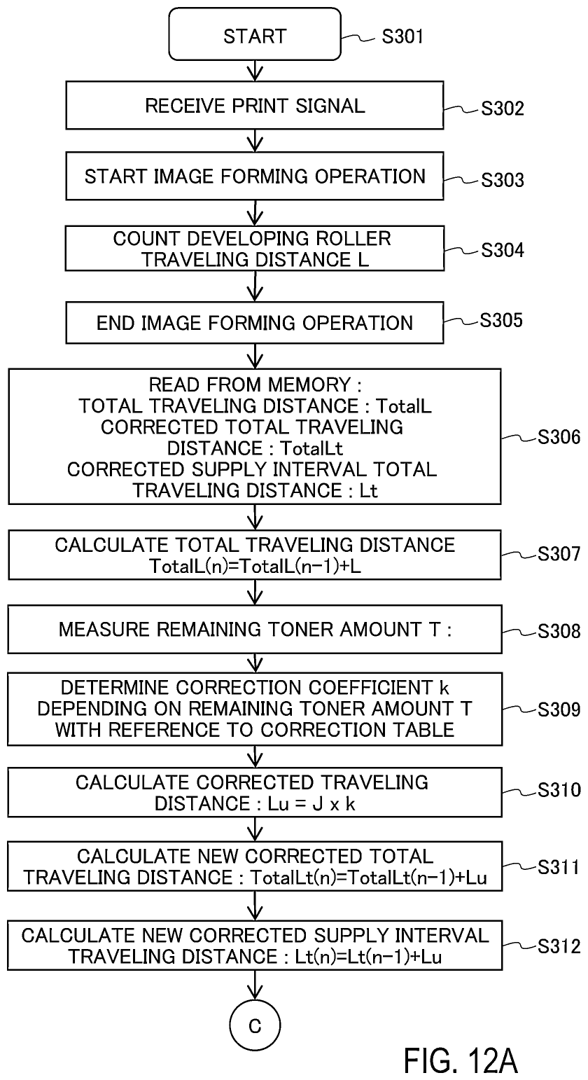

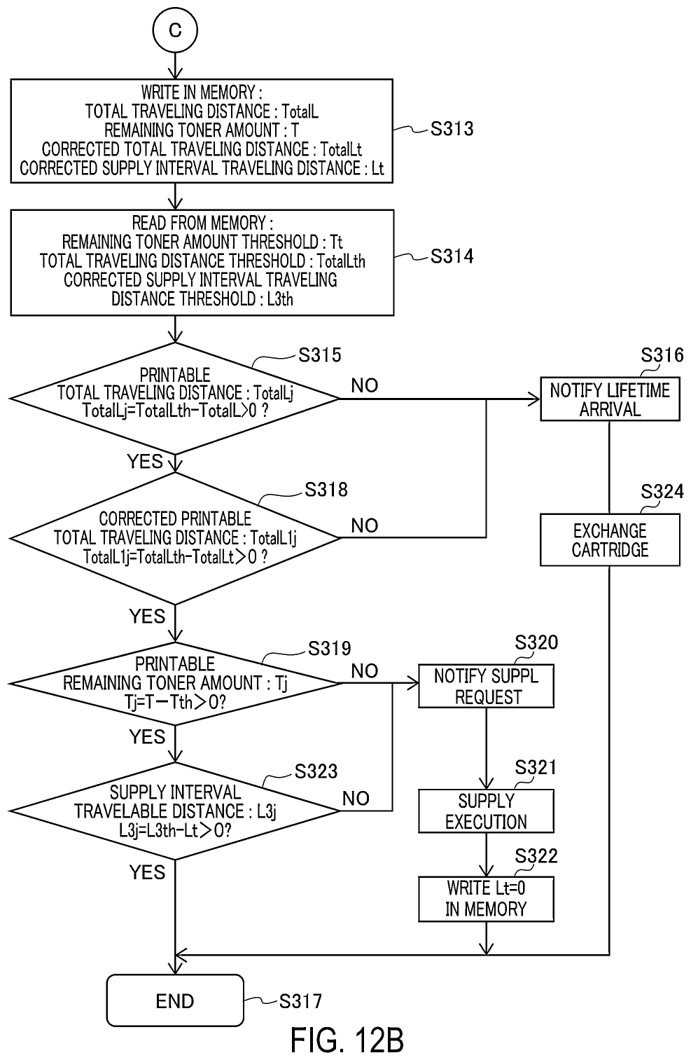

FIGS. 12A and 12B are flowcharts showing a supply timing of the toner to the developing device 8 or a sequence for discriminating the lifetime of the developing device 8 in the embodiment 3. The controller 200 performs respective processing shown in the flowcharts of FIGS. 12A and 12B and detects a supply requirement timing of the toner to the developing device 8 and the lifetime of the developing device 8, and then notifies the user of a result thereof.

First, from a start (S301), a print signal is sent to the image forming apparatus 100 (S302). Then, the image forming operation is started (S303), the developing roller traveling distance L during the image forming operation is counted (S304), and then the image forming operation is ended (S305).

Next, from the memory 15, the total traveling distance TotalL to the present (until immediately before execution of the image forming operation of S303 to S305) until the present, the corrected total traveling distance TotalL until the present, and the corrected supply traveling distance until the present are read. (S306).

Then, a total traveling distance TotalL(n−1) to the present read in S306 is represented by Total(n−1), and the traveling distance L in which the developing roller traveled in a current image forming operation is added thereto, so that a latest total traveling distance TotalL(n) is (S307). A calculation formula of the latest total traveling distance Total(n) is the formula (4) used in the embodiment 1.

Next, the remaining toner amount T is measured (S308).

Then, by making reference to a correction table (FIG. 13) stored in the memory 15 in advance, a correction coefficient k depending on the remaining toner amount T is determined (S309).

Next, by using the selected correction coefficient k, a corrected traveling distance Lu is calculated by the following formula (8) (S310).

$$Lu = L \times k \qquad formula ( 8 )$$

The corrected total traveling distance until the present read in S306 is represented by TotalLt(n−1), and the corrected traveling distance Lu calculated by the formula (8) is added, so that a latest corrected total traveling distance TotalLt(n) is calculated (S311). The latest corrected total traveling distance TotalLt(n) is calculated by the following formula (9).

$$TotalLt ( n ) = TotalLt ( n - 1 ) + Lu \qquad formula ( 9 )$$

The corrected traveling distance Lu is a corrected traveling distance obtained by correcting the movement distance of the developing roller 4 in a predetermined section on the basis of remaining amount information which is information relating to the toner amount of the toner in the toner accommodating chamber 8a. The corrected total traveling distance TotalLt is a corrected cumulative movement distance obtained by integrating the corrected movement distance from initial use of the developing device 8.

Next, the corrected supply interval traveling distance until the present read in S306 is represented by Lt(n−1), and the corrected traveling distance Lu calculated by the formula (8) is added thereto, so that a latest corrected supply interval traveling distance Lt(n) is calculated (S312). The latest corrected supply interval traveling distance Lt(n) is calculated by the following formula (10).

$$Lt ( n ) = Lt ( n - 1 ) + Lu \qquad formula ( 10 )$$

The corrected supply interval traveling distance Lt is a corrected supply interval movement distance obtained by integrating the corrected movement distance from execution of the last toner supply.

Then, TotalL(n) calculated in S307 is written as the latest total traveling distance TotalL in the memory 15. Further, TotalLt(n) calculated in S311 is written as the latest corrected total traveling distance TotalLt in the memory 15. Further, Lt(n) calculated in S312 is written as the latest corrected supply interval traveling distance TotalLt, in the memory 15. Further, the remaining toner amount measured in S308 is written as a latest remaining toner amount T in the memory 15 (S313).

Next, from the memory 15, the remaining toner amount threshold Tth, the total traveling distance threshold TotalLth, and the supply execution supply interval traveling distance threshold L3th are read (S314).

First, the printable total traveling distance TotalLj is calculated from the formula (2) described in the embodiment 1, and whether or not a relationship of TotalLj>0 is satisfied is discriminated (S315).

In the case where TotalLj>0 is not satisfied (S315: NO), the printable traveling distance does not remain, and therefore, lifetime arrival is notified (S316), and exchange of the process cartridge 9 is executed (S324), and then the processing goes to “END” (S317).

In the case where TotalLj>0 is satisfied (S315: YES), a corrected printable total traveling distance TotalL1j is calculated by the following formula (11), so that whether or not there is a remaining amount is discriminated (S318).

$$TotalL 1 j = TotalLth - TotalLT \qquad formula ( 11 )$$

That is, the corrected printable total traveling distance TotalL1j is a value showing a printable corrected supply interval traveling distance from the present time (TotalLt) to arrival at the end of the lifetime.

In the case where TotalL1j>0 is not satisfied (S318: NO), the printable traveling distance does not remain, and therefore, lifetime arrival is notified (S316), and the processing goes to “END” (S317).

In the case where TotalL1j>0 is satisfied (S318: YES), the printable traveling distance remain, and therefore, the printable remaining toner amount Tj is calculated from the formula (1) described in the embodiment 1, and whether or not a relationship of Tj>0 is satisfied is discriminated (S319).

In the case where Tj>0 is not satisfied (S319: NO), printable toner does not remain, and therefore, toner supply requirement is notified (S320). Thereafter, the supplying operation is executed (S321), and the corrected supply interval traveling distance in the memory 5 is updated to Lt=0 (S322), and then the processing goes to “END” (S317).

In the case where Tj>0 is satisfied (S319: YES), a corrected pre-supply execution travelable L3j is calculated from the following formula (12), and whether or not there is a remaining amount is discriminated (S323).

$$L 3 j = L 3 th - Lt \qquad formula ( 12 )$$

In the case where L1j>0 is not satisfied (S323: NO), the supply is needed, and therefore, toner supply requirement is notified (S320). Thereafter, the supplying operation is executed (S321), and the corrected supply interval traveling distance in the memory 15 is updated to Lt=0 (S322), and the processing goes to “END” (S317).

In the case where L3j>0 is satisfied (S323: YES), the travelable distance remains, and therefore, the processing goes to “END” (S317). By executing this series of the flowcharts, in the case where the corrected total traveling distance TotalLt (corrected cumulative movement distance) becomes the total traveling distance threshold TotalLth or more (lifetime discrimination threshold or more), notification to the effect that the developing device 8 reached the end of the lifetime thereof is provided. Further, in the case where the remaining toner amount T becomes the remaining toner amount threshold Th or less, supply requirement notification is provided. Further, in the case where the corrected supply interval traveling distance Lt (corrected supply interval movement distance) becomes the supply execution supply interval traveling distance threshold L3th or more (third supply discrimination threshold or more), the supply requirement notification is provided.

In the embodiment 3, supply execution discrimination can be made on the basis of the corrected traveling distance obtained by correcting an actual traveling distance depending on the remaining toner amount. In an example shown in FIG. 13, the correction coefficient is larger with a larger remaining toner amount, and therefore, the corrected traveling distance is counted long. That is, in correction of the movement distance based on remaining toner amount information, correction is made so that the corrected movement distance becomes longer with a larger remaining toner amount. Accordingly, in a use situation such that the low print ratio printing is executed in many cases and the toner use amount is small, an integrated value of the corrected traveling distance is liable to increase, so that the toner supply is executed early. By this, before the fog due to the filming occurs, it is possible to notify the user of the supplying operation requirement of the toner to the developing device 8 8 and the lifetime of the developing device 8. A method of the lifetime notification may be a method of notifying the user of arrival at an end of the lifetime by the operation panel 60 or the like or may be a method in which the image forming operation is stopped.

Incidentally, in the embodiment 3, an example in which discrimination as to whether or not the travelable distance until the toner supply is executed remains is made by using the supply execution supply interval traveling distance threshold L3th was described, but the discrimination may be made by using L1th used in the embodiment 1 or L2th used in the embodiment 2.

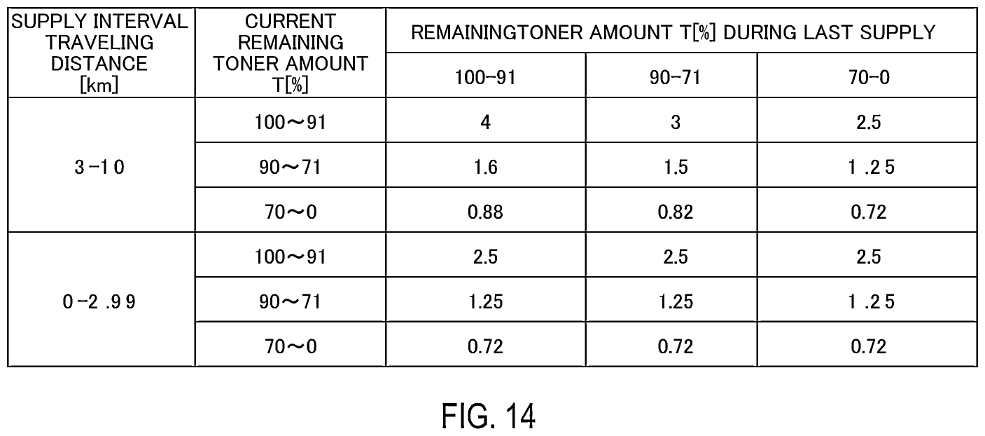

Further, in the embodiment 3, an example in which the correction coefficient is determined depending on only the remaining toner amount was described, but the correction coefficient may be determined depending on another condition. For example, the correction coefficient may also be determined, in addition to the remaining toner amount, depending on the supply interval traveling distance at a timing of execution of the toner supply or the remaining toner amount during the last toner supply. In an example shown in FIG. 14, the correction coefficient is larger when the supply interval traveling distance is longer, and therefore, the corrected traveling distance is counted longer with an increasing traveling distance. That is, the corrected traveling distance becomes a further corrected value so as to become a larger value with a larger value of the supply interval traveling distance obtained by integrating the movement distance from the last toner supply. Accordingly, in a use status such that the low print ratio printing is executed in many cases and the traveling distance is liable to increase, an integrated value of the corrected traveling distance is liable to increase, so that the toner supply is executed early. Further, the correction coefficient is larger with a larger remaining toner amount during the last toner supply. That is, the corrected traveling distance becomes a further corrected value so as to become a larger value with a larger remaining toner amount when the last toner supply is made. For that reason, in a situation in which the low print ratio printing such that the toner supply is executed in a situation in which the toner use amount is small, the integrated value of the corrected traveling distance becomes liable to increase, so that the toner supply is executed earlier. Thus, it becomes possible to use an appropriate correction coefficient depending on the degree of the toner deterioration in the developing device 8 and the degree of the developing roller 4 during the supplying operation. Incidentally, in an example of FIG. 14, an example in which the correction coefficient is changed to two levels depending on the supply interval traveling distance was described, but the correction coefficient may also be changed more finely depending on the supply interval traveling distance. For example, setting is made so that the correction coefficient becomes larger with a longer supply interval traveling distance. By this, it becomes possible to notify the supply requirement earlier in a use situation in which the low print ratio printing is executed in many cases and the traveling distance is liable to increase.

### Evaluation Experiment of Embodiment 3

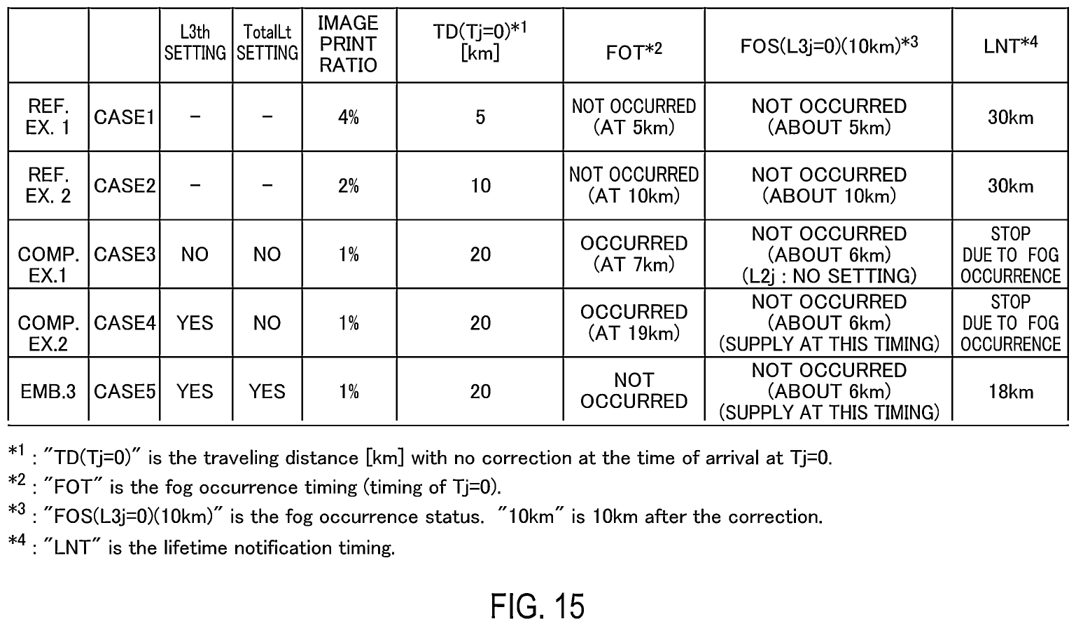

On 30,000 sheets of recording materials, images were formed by using image data for an experiment. Lateral line patterns of three types of 4%, 2%, and 1% in image print ratio were used. Further, the correction coefficient shown in FIG. 13 was set. Further, the supply execution supply interval traveling distance threshold L3th was set to 10 km, and the total traveling distance threshold TotalLth was set to 30 km. In FIG. 15, a result when the experiment was conducted was shown. Each of four cases 1 to 5 will be described.

### Case 1 (Reference Example 1): High Print Ratio Printing (Image Print Ratio: 4%)

Into high print ratio printing, a timing when the toner consumption progresses and the printable remaining toner amount Tj becomes 0 became a point of time of the total traveling distance TotalL=5 km. Further, at a point of time when the developing roller actually travels 5 km, the corrected supply interval traveling distance TotalLt, becomes 10 km, so that the supply execution supply interval traveling distance L3th set in advance reached 10 km. In this case, the toner is consumed before degrees of the toner deterioration and the consumption of the developing roller progress, so that there was no occurrence of the fog and a toner supply timing comes. Further, the supplying operation is performed every 5 km so s to be the total traveling distance TotalL=5 km, 10 km, . . . . By this, the deteriorated toner in the developing device is replaced with new (fresh) toner, so that the influences by the toner deterioration and the consumption of the developing roller are alleviated, so that the image forming apparatus was subsequently able to be used until the total traveling distance threshold TotalLth=30 km with no occurrence of the fog. Thereafter, by repeating the toner supply every 5 km, the lifetime notification was provided at the total traveling distance threshold TotalLth=30 km.

### Case 2 (Reference Example 2): Low Print Ratio Printing (Image Print Ratio: 2%)

The print ratio was half of the print ratio in the case 1, and therefore, the timing when the printable remaining toner amount Tj becomes 0 between a point of time of the total traveling distance TotalL=10 km which is twice the total traveling distance TotalL in the case 1. Further, at a point of time when the developing roller actually travels 10 km, the corrected supply interval traveling distance TotalLt becomes 10 km, so that the supply execution supply interval traveling distance L3th set in advance reached 10 km. Compared with the case 1, the toner consumption amount is small, and therefore, although the consumption degree of the developing roller progresses, there is no occurrence of the fog, and the toner supply timing has come. Further, similarly as in the case 1, the supplying operation is performed every 10 km so as to be the total traveling distance TotalL=10 km, 20 km, . . . . By this, the deteriorated toner in the developing device is replaced with the new toner, so that the influences by the toner deterioration and the consumption of the developing roller are alleviated, so that the image forming apparatus was subsequently able to be used until the total traveling distance threshold TotalLth=30 km with no occurrence of the fog. Thereafter, by repeating the toner supply every 10 km, the lifetime notification is provided at the total traveling distance threshold TotalLth=30 km.

### Case 3 (Comparison Example 1): Low Print Ratio Printing (Image Print Ratio: 1%)

The print ratio was lowered than the print ratio in the case 2, and therefore, the timing when the printable remaining toner amount Tj becomes 0 became a point of time of the total traveling distance Total L=20 km. The toner consumption amount is further smaller than the toner consumption amount in the case 2, and therefore, the degrees of the toner deterioration and the consumption of the developing roller further progress, so that the fog occurred at a point of time of the total traveling distance TotalL=7 km before the timing of Tj=0.

### Case 4 (Comparison Example 2): Low Print Ratio Printing (Image Print Ratio: 1%)+L3j is Set

In a case similar to the case 3, when the corrected supply interval traveling distance Lt is calculated by using a correction coefficient set in advance, at a timing when the developing roller traveled 6 km as the supply interval traveling distance with no correction, Lt reached the supply execution supply interval traveling distance threshold L2th=10 km. By this, the supplying operation was executed at a point of time of 6 km before 7 km in which the fog occurs. Thereafter, the supplying operation is executed every 6 km, but after third supply is executed at a point of time of arrival at 18 km, the fog occurred at 19 km. That is, the fog occurred at 19 km while most of the toner supplied by the third supply cannot be used. This shows that the toner deterioration in the developing device and the developing roller consumption immediately before the toner supply progress and the influences thereof cannot be alleviated even when the new toner is supplied by the supplying operation and thus it is difficult to further continuously use the developing device. The fog occurred at 19 km, and therefore, evaluation was stopped before the total traveling distance reaches the total traveling distance threshold TotalLth=30 km.

### Case 5 (Embodiment 3): Low Print Ratio Printing (Image Print Ratio: 1%)+(L3j, TotalLt) is Set

In the embodiment 3, at a point of time when a total traveling distance TotalL with no correction is 18 km and when third toner supply is executed, the corrected total traveling distance TotalLt reaches the total traveling distance threshold Totalth=30 km, and the lifetime notification is provided at this timing. By this, the user is capable of using the image forming apparatus 100 by executing exchange the developing device 8 or the like with no occurrence of the fog and without wasting the toner supplied to the developing device 8.

As described above, the correction coefficient for correcting the development traveling distance and the corrected total traveling distance are set, and the toner supply is executed before the fog occurs. By this, it is possible to provide the image forming apparatus in which the lifetime notification is provided so as not to useless executing the toner supply, without suppressing the occurrence of the fog.

An embodiment 4 is characterized in that in addition to the parameters described in the embodiment 1, a toner supply amount ΔT last supplied from the toner pack 16 is set and then a correction coefficient k depending on the toner supply amount ΔT is used. In the embodiment 4, a portion overlapping with the portions in the embodiments 1 and 3 will be omitted from description, and a portion peculiar to the embodiment 4 will be described.

In the embodiment 4, even in the case where the supplied toner is small in amount and in the case where the supplied toner is large in amount, by setting a correction coefficient k in consideration of progress of the toner deterioration and the consumption of the developing roller 4, it becomes possible to notify supply requirement at an appropriate timing. By this, it becomes possible to suppress the occurrence of the fog while suppressing the toner deterioration in the developing device 8 and the consumption of the developing roller 4.

FIGS. 6A and 6B are flowcharts showing a supply timing of the toner to the developing device 8 or a sequence for discriminating the lifetime of the developing device 8 in the embodiment 4. The controller 200 performs respective processing shown in the flowcharts of FIGS. 6A and 6B and detects a supply requirement timing of the toner to the developing device 8 and the lifetime of the developing device 8, and then notifies the user of a result thereof.

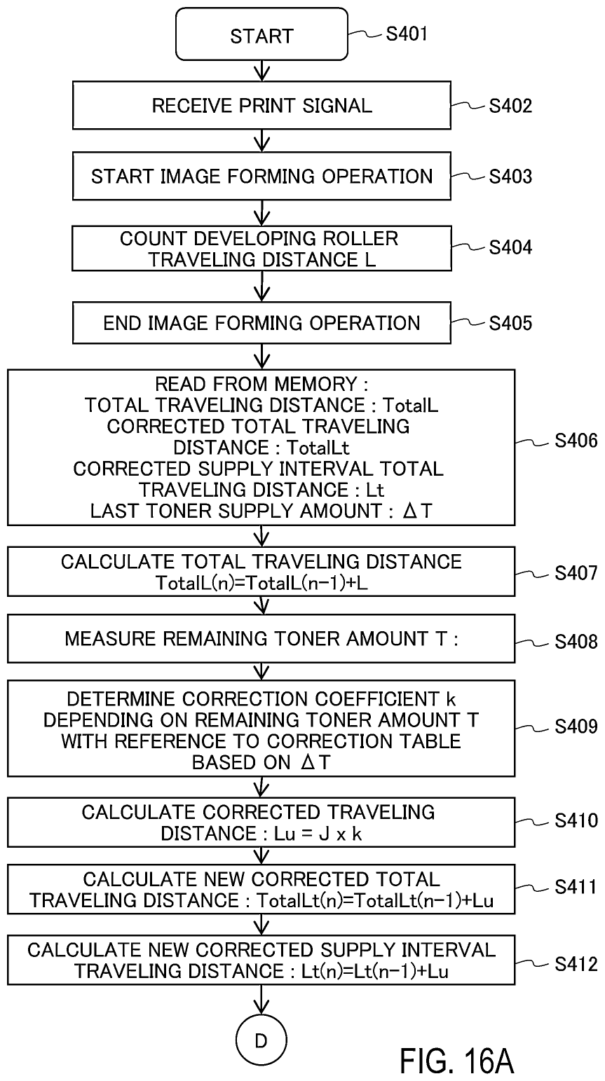

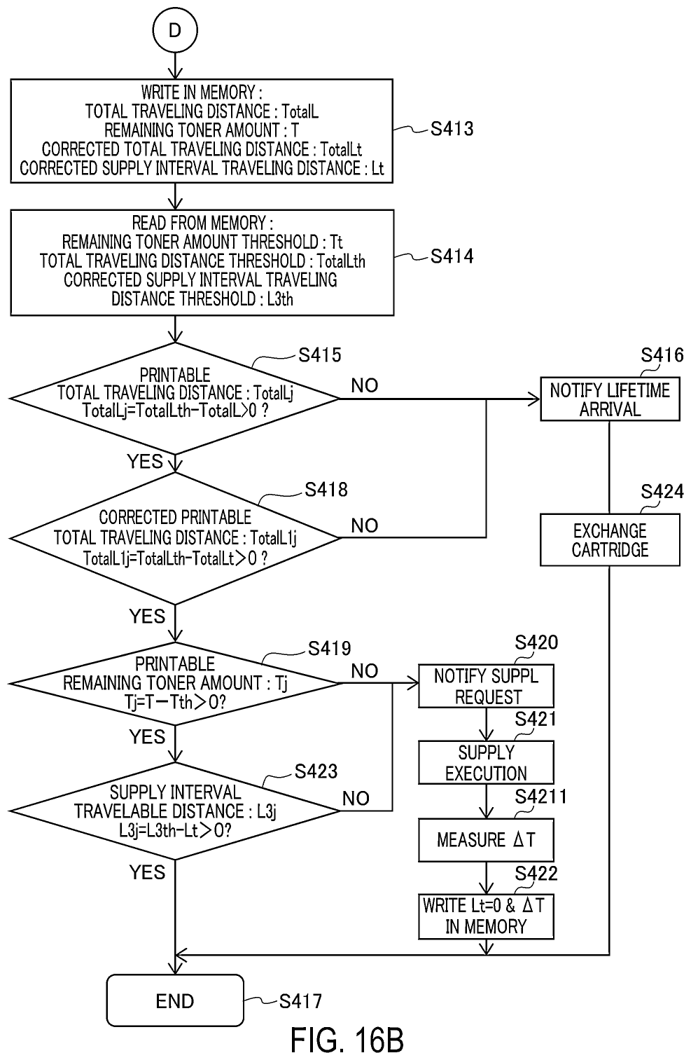

The flowcharts of FIGS. 16A and 16B are roughly in common with the flowcharts of FIGS. 12A and 12B in the embodiment 3. That is, S401 to S405, S407 to S408, S410 to S421, and S423 to S424 are the same as S301 to S305, S307 to S308, S310 to S321, and S323 to S324, respectively, in the flowcharts of FIGS. 12A and 12B. S406, S409, and S422 are different from S306, S309, and S322, respectively, and S4211 which is not performed in the flowcharts of FIGS. 12A and 12B is added. In the following, contents different from the contents of FIGS. 12A and 12B will be described.

At a timing of the toner supply in S421, measurement of the toner supply amount ΔT is executed (S4211), and the corrected supply interval traveling distance Lt=0 and information on the toner supply amount ΔT are written into the memory 15 (S422). Here, the written toner supply amount ΔT during the last toner supply is read from the memory 15 (S406), and on the basis of the read toner supply amount ΔT, by making reference to the correction table, the correction coefficient k is determined (S409).

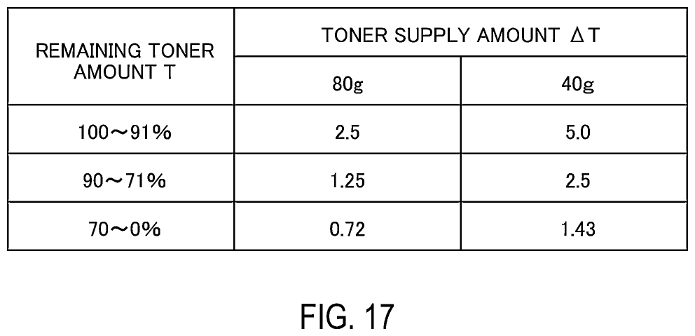

In FIG. 17, an example of the correction table is shown. In each of the case where the toner supply amount ΔT is 80 g and the case where the toner supply amount ΔT is 40 g, the correction coefficient the remaining toner amount depending on T is determined. Thus, it becomes possible to select the correction coefficient depending on the last toner supply amount. In the case where the toner supply amounts are different from each other, manners of progression of the toner deterioration and the degree of the consumption of the developing roller 4 are different. Specifically, in the case where the toner supply amount is small, the toner deterioration in the developing device 8 and the degree of consumption of the developing roller 4 progress. In an example of FIG. 17, the correction coefficient is larger with a smaller toner supply amount, and therefore, the corrected supply interval traveling distance Lt becomes longer. That is, the corrected movement distance becomes a further corrected value so as to become a larger value with a smaller supply amount when the last toner supply is executed. For that reason, supply discrimination and lifetime discrimination are made early, so that it becomes possible to suppress the occurrence of the fog and unnecessary toner supply.

Incidentally, in the embodiment 4, an example in which the toner supply amount ΔT is acquired by actual measurement was shown, but the present invention is not limited to this example. For example, information indicating the toner amount of the toner filled in the toner pack is stored in a memory provided to the toner pack, a communicating means with the memory of the toner pack is provided to the apparatus main assembly M or the developing device 8. Then, by receiving the information from the memory of the toner pack at a timing of the supplying operation, the toner supply amount is acquired, and then may be written into the memory 15.

Further, in the case where product information such as a model number or the like of the toner pack is stored in the memory provided to the toner pack, the communicating means with the memory of the toner pack is provided to the apparatus main assembly M or the developing device 8. Further, a table indicating a correspondence relationship between the product information of the toner pack and the toner amount of the toner filled in the toner pack is stored in advance in the memory 15. Then, the product information is received from the memory of the toner pack and the toner amount corresponding to the product information is acquired, and then may be written into the memory 15.

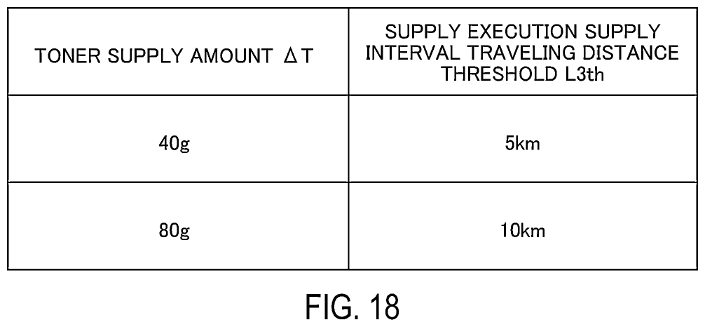

Further, in the embodiment 4, an example in which the correction coefficient is determined on the basis of the toner supply amount ΔT was shown, but as shown in FIG. 18, the supply execution supply interval traveling distance threshold L3th may be set depending on the toner supply amount ΔT. In this case, the correction coefficient may be determined depending on only the remaining toner amount T similarly as in the embodiment 3. In an example of FIG. 18, the supply execution supply interval traveling distance threshold L3th (third supply discrimination threshold) is lower with a smaller toner supply amount ΔT when the last toner supply is executed. Accordingly, in a situation in which the toner deterioration in the developing device 8 and the degree of the consumption of the developing roller 4 are liable to progress and in which the toner supply amount is small, the supply discrimination is made early.

An embodiment 5 is characterized in that in addition to the parameters described in the embodiment 3, different correction coefficients are used every number of times of supply executed. In the embodiment 5, a portion overlapping with the portions in the embodiments 1 and 3 will be omitted from description, and a portion peculiar to the embodiment 5 will be described.

In the embodiment 5, by setting a correction coefficient k in consideration of progress of the toner deterioration and the degree of the consumption of the developing roller 4 in the developing device 8 due to an increase in number of times of the supply, it becomes possible to notify supply requirement at an appropriate timing. By this, it becomes possible to suppress the occurrence of the fog while suppressing the toner deterioration in the developing device 8 and the consumption of the developing roller 4.

FIGS. 9A and 9B are flowcharts showing a supply timing of the toner to the developing device 8 or a sequence for discriminating the lifetime of the developing device 8 in the embodiment 5. The controller 200 performs respective processing shown in the flowcharts of FIGS. 9A and 9B and detects a supply requirement timing of the toner to the developing device 8 and the lifetime of the developing device 8, and then notifies the user of a result thereof.

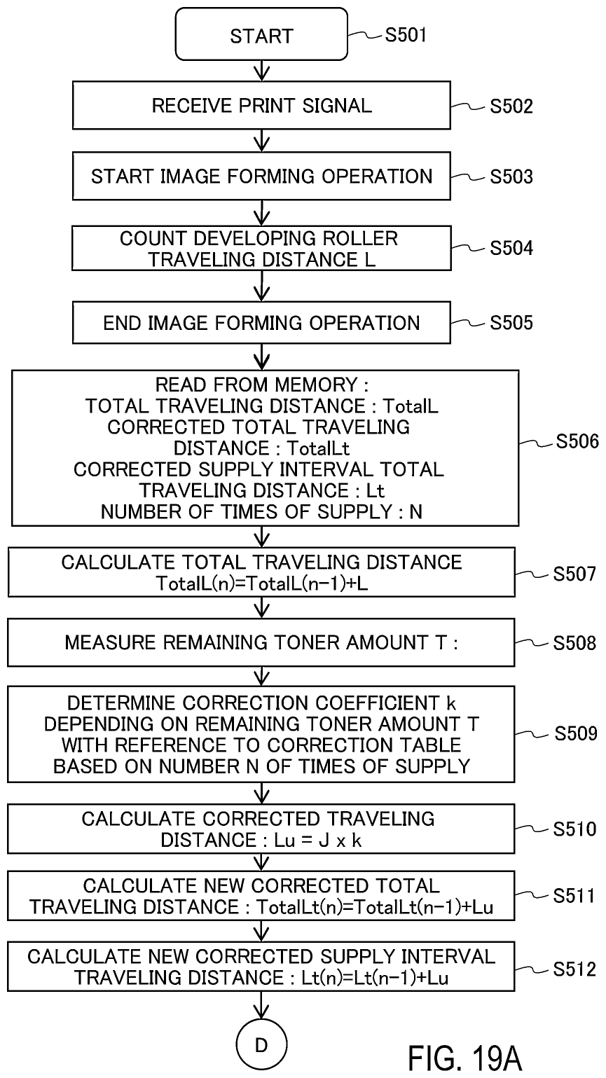

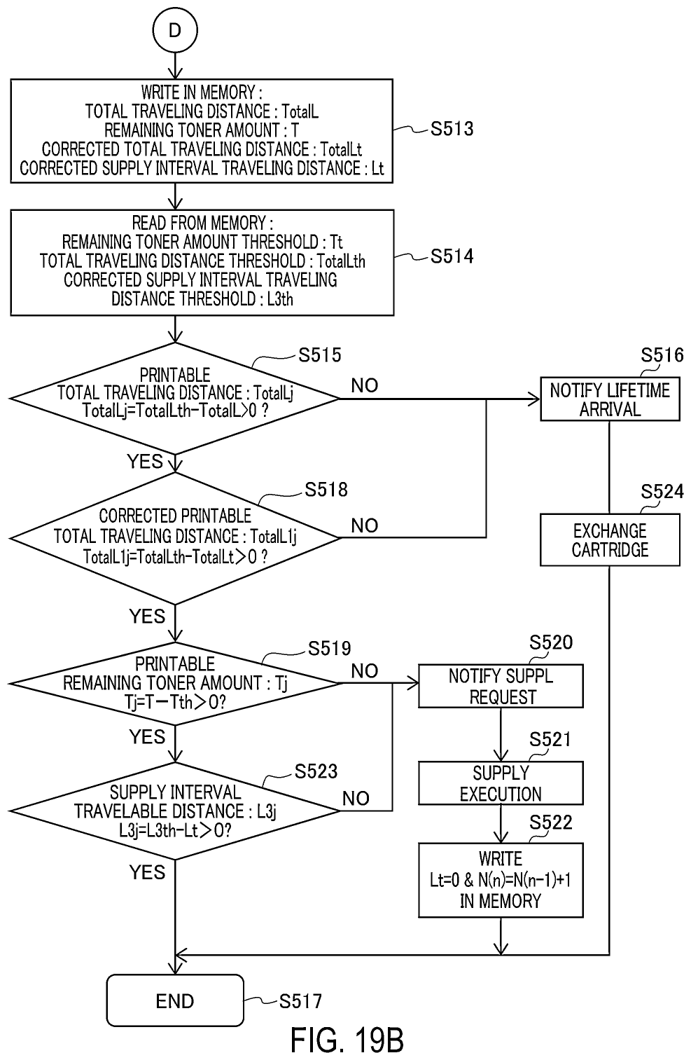

The flowcharts of FIGS. 19A and 19B are roughly in common with the flowcharts of FIGS. 12A and 12B in the embodiment 3. That is, S501 to S505, S507 to S508, S510 to S521, and S523 to S524 are the same as S301 to S305, S307 to S308, S310 to S321, and S323 to S324, respectively, in the flowcharts of FIGS. 12A and 12B. S506, S509, and S522 are different from S306, S309, and S322, respectively. In the following, contents different from the contents of FIGS. 12A and 12B will be described.

After execution of the supplying operation (S521), the corrected supply interval traveling distance Lt=0 and a latest number of times of supply N are written into the memory 15 (S522). Here, in the case where the number of times of supply until the last supply read in S506 is N(n−1) and the latest number of times of supply is N(n), the latest number of times of supply is calculated by N(n)=N(n−1)+1. The thus calculated N(n) is written as the latest number of times of supply N into the memory 15 (S522). Here, the written number of times of supply N is read from the memory 15 (S506), and on the basis of the read number of times of supply N, by making reference to the correction table, the correction coefficient k is determined (S509).

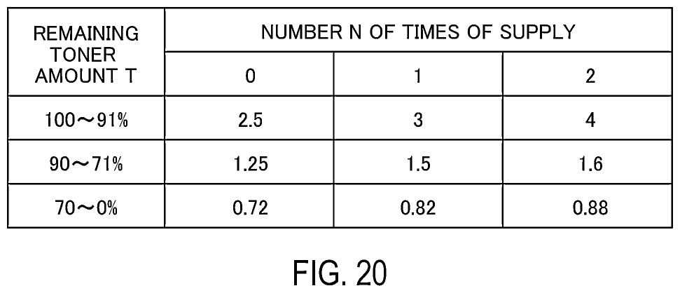

In FIG. 20, an example of the correction table is shown. In each of the cases where the number of times of supply is 0, 1, and 2, the correction coefficient the remaining toner amount depending on T is determined. Thus, it becomes possible to select the correction coefficient depending on the number of times of toner supply. By an increase in number of times of supply, the toner deterioration in the developing device 8 and the degree of consumption of the developing roller 4 progress. As shown in FIG. 20, the correction coefficient is increased with an increasing number of times of supply N, so that the corrected supply interval traveling distance Lt becomes longer. That is, the corrected movement distance becomes a further corrected value so as to become a larger value with an increasing number of times when the toner supply is executed. For that reason, supply discrimination and lifetime discrimination are made early, so that it becomes possible to suppress the occurrence of the fog and unnecessary toner supply.

Incidentally, in the embodiment 5, an example in which the correction coefficient is determined on the basis of number of times of supply N was shown, but similarly as in FIG. 18, the supply execution supply interval traveling distance threshold L3th may be set depending on the number of times of supply N. In this case, the correction coefficient may be determined depending on only the remaining toner amount T similarly as in the embodiment 3. The supply execution supply interval traveling distance threshold L3th is made smaller with a larger number of times of supply N. By this, in a situation in which the toner deterioration in the developing device 8 and the degree of the consumption of the developing roller 4 are liable to progress and in which the number of times of supply is large, the supply discrimination is made early.

Incidentally, the reason why the correction coefficient is made large with an increasing number of times of supply in the embodiment 5 is that a situation in which the low print ratio printing is successively executed is assumed. For example, there is a situation such that a low print ratio printing mode is selectable in the image forming apparatus 100 and a printing mode is set to the low print ratio printing mode. In the case where high print ratio printing is executed even once, it would be considered that the degrees of the toner deterioration and the consumption of the developing roller 4 are improved.

Incidentally, in the embodiments 3 to 5, an example in which the traveling distance L and the total traveling distance TotalL are changed depending on the remaining toner amount T was described. However, depending on a first parameter relating to progression of the toner deterioration and the developing roller consumption, a second parameter used for supply discrimination and lifetime discrimination may be contained. As the first parameter, for example, it is possible to cite a use environment (temperature, humidity, or the like) of the image forming apparatus 100, the number of times supply N of the toner, and the like. Further, it is also possible to cite the remaining toner amount T, the toner supply amount ΔT, the supply interval traveling distance RefillL, the total traveling distance TotalL, the corrected supply interval traveling distance Lt, and the like when the last toner supply is executed. On the other hand, as the second parameter, it is possible to cite the total traveling distance threshold TotalLth, the supply execution traveling distance threshold L1th, the supply execution supply interval traveling distance threshold L2th, the supply execution supply interval traveling distance threshold L3th, the correction coefficient k, and the like. A method of changing the second parameter depending on the first parameter may be such that in a situation in which the toner deterioration and the developing roller consumption are liable to progress, the second parameter is changed depending on the first parameter so that the supply requirement notification and the lifetime arrival notification can be made earlier.

Further, in the above-described embodiments, an example in which the lifetime notification is provided in the case where the total traveling distance TotalL and the corrected total traveling distance TotalLt reach the total traveling distance threshold TotalLth was shown, but a condition in which the lifetime notification is provided is not limited thereto. For example, the lifetime arrival notification may be provided in the case where the number of times of supply becomes a predetermined threshold or more.

According to the present invention, in the image forming apparatus in which the developing device to which the supply container for supplying the developer is detachably mountable is included, it becomes possible to more appropriately notify a supply timing of the developer to the developing device and the end of the lifetime of the developing device.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-141097 filed on Aug. 31, 2023, which is hereby incorporated by reference herein in its entirety.

What is claimed is:

1. An image forming apparatus comprising:
a photosensitive drum on which an electrostatic latent image is formed on a surface thereof;
a developing unit which includes an accommodating portion for accommodating a developer and a developing roller for supplying the developer from the accommodating portion to the photosensitive drum and to which a supply container for supplying the developer to the accommodating portion is detachably mountable;
a notifying portion configured to provide notification to a user; and
a controller configured to control the notifying portion,
wherein in a case where a cumulative movement distance obtained by integrating a movement distance of the developing roller in a predetermined section of a surface of the developing roller from initial use of the developing unit is a predetermined first supply discrimination threshold or more, the controller controls the notifying portion so as to provide notification prompting the user to supply the developer.

2. The image forming apparatus according to claim 1, wherein in a case where a supply interval movement distance obtained by integrating the movement distance of the developing roller in the predetermined section of the surface of the developing roller from the last supply of the developer is a predetermined second supply discrimination threshold or more, the controller controls the notifying portion so as to provide the notification prompting the user to supply the developer.

3. The image forming apparatus according to claim 2, wherein in a case where a use amount of the developer from the last supply of the developer is a predetermined threshold or less and the supply interval movement distance is the second supply discrimination threshold or more, the controller controls the notifying portion so as to provide the notification prompting the user to supply the developer.

4. The image forming apparatus according to claim 1, wherein in a case where a corrected supply interval movement distance obtained by integrating a corrected movement distance, from the last supply of the developer, which is a value obtained by correcting the movement distance of the developing roller in the predetermined section of the surface of the developing roller on the basis of remaining amount information which is information relating to an amount of the developer accommodated in a accommodating portion is a predetermined third supply discrimination threshold or more, the controller controls the notifying portion so as to provide the notification prompting the user to supply the developer.

5. The image forming apparatus according to claim 4, wherein as the third discrimination threshold, a lower value is used with a smaller supply amount of the developer when the last supply of the developer is executed.

6. The image forming apparatus according to claim 4, wherein in correction on the basis of the remaining amount information, the correction is made so that the corrected movement distance becomes larger with a larger amount of the developer accommodated in the accommodating portion.

7. The image forming apparatus according to claim 4, wherein the corrected movement distance is a value further corrected so as to become a larger value with a larger amount of the developer accommodated in the accommodating portion when the last supply of the developer is executed.

8. The image forming apparatus according to claim 4, wherein the corrected movement distance is a value further corrected so as to become a large value with a larger supply interval movement distance obtained by integrating the movement distance of the developing roller in the predetermined section of the surface of the developing roller from the last supply of the developer.

9. The image forming apparatus according to claim 4, wherein the corrected movement distance is a value further corrected so as to become a larger value with a smaller supply amount of the developer when the last supply of the developer is executed.

10. The image forming apparatus according to claim 4, wherein the corrected movement distance is a value further corrected so as to become a larger value with a larger number of times of supply of the developer.

11. The image forming apparatus according to claim 1, wherein in a situation that deterioration of the developer or consumption of the developing roller is liable to progress, the controller controls the notifying portion so as to early provide the notification so that depending on a first parameter relating to progression of the deterioration of the developer or the consumption of the developing roller, a second parameter used when the notifying portion makes discrimination of the notification is changed.

12. The image forming apparatus according to claim 1, wherein the first parameter is at least either one of a use environment of the image forming apparatus, a number of times of supply of the developer, an amount of the developer accommodated in the accommodating portion when the last supply of the developer is executed, a supply amount of the developer when the last supply of the developer is executed, the cumulative movement distance from the initial use of the developing unit when the last supply of the developer is executed, and a supply interval movement distance of the developing unit when the last supply of the developer is executed.

13. The image forming apparatus according to claim 11, wherein the second parameter is at least either one of a first supply discrimination threshold, a second supply discrimination threshold, a third supply discrimination threshold, and a correction coefficient used for calculating a corrected movement distance.

14. An image forming apparatus comprising:
a photosensitive drum on which an electrostatic latent image is formed on a surface thereof;
a developing unit which includes an accommodating portion for accommodating a developer and a developing roller for supplying the developer from the accommodating portion to the photosensitive drum and to which a supply container for supplying the developer to the accommodating portion is detachably mountable;
a notifying portion configured to provide notification to a user; and
a controller configured to control the notifying portion,
wherein in a case where a cumulative movement distance obtained by integrating a movement distance of the developing roller in a predetermined section of a surface of the developing roller from initial use of the developing unit is a predetermined lifetime discrimination threshold or more, the controller controls the notifying portion so as to provide notification to the effect that the developing unit reaches an end of a lifetime thereof.

15. The image forming apparatus according to claim 14, wherein in a case where a corrected cumulative movement distance obtained by integrating a corrected movement distance, from initial use of the developing unit, which is a value obtained by correcting the movement distance of the developing roller in the predetermined section of the surface of the developing roller on the basis of remaining amount information which is information relating to an amount of the developer accommodated in the accommodating portion is the predetermined lifetime discrimination threshold or more, the controller controls the notifying portion so as to provide notification to the effect that the developing unit reaches the end of the lifetime thereof.

16. The image forming apparatus according to claim 14, wherein in a case where a number of times of supply of the developer is a predetermined threshold or more, the controller controls the notifying portion so as to provide notification to the effect that the developing unit reaches the end of the lifetime thereof.

17. The image forming apparatus according to claim 1, wherein the movement distance in the predetermined section is a movement distance from a start to an end of an image forming operation.

18. The image forming apparatus according to claim 14, wherein the movement distance in the predetermined section is a movement distance from a start to an end of an image forming operation.

19. The image forming apparatus according to claim 1, wherein the developing unit is included in a cartridge detachably mountable to a main assembly of the image forming apparatus.

20. The image forming apparatus according to claim 14, wherein the developing unit is included in a cartridge detachably mountable to a main assembly of the image forming apparatus.
